(19) United States
(12) Patent Application Publication
(10) Pub. No.: US 2019/0082178 A1
(43) Pub. Date: Mar. 14, 2019

(54) METHOD AND APPARATUS FOR ENCODING AND DECODING VIDEO USING PICTURE DIVISION INFORMATION

(71) Applicant: Electronics and Telecommunications Research Institute, Daejeon (KR)

(72) Inventors: Youn-Hee KIM, Daejeon (KR); Jin-Wuk SEOK, Daejeon (KR); Hui-Yong KIM, Daejeon (KR); Myung-Seok KI, Daejeon (KR); Sung-Chang LIM, Daejeon (KR); Jin-Soo CHOI, Daejeon (KR)

(73) Assignee: Electronics and Telecommunications Research Institute, Daejeon (KR)

(21) Appl. No.: 16/084,995

(22) PCT Filed: Mar. 30, 2017
(86) PCT No.: PCT/KR2017/003496

§ 371 Date: Sep. 14, 2018

(30) Foreign Application Priority Data
Mar. 30, 2016 (KR) 10-2016-0038461
Mar. 30, 2017 (KR) 10-2017-0040439

(51) Int. Cl. H04N 19/119; H04N 19/114; H04N 19/174; H04N 19/136

(52) U.S. Cl. CPC H04N 19/119; H04N 19/136; H04N 19/174; H04N 19/114

(57) ABSTRACT

Disclosed herein are a method and apparatus for video encoding and decoding using picture partition information. Each of the pictures in a video is partitioned into tiles or slices based on picture partition information. Each picture is partitioned using one of at least two different methods based on the picture partition information. The picture partition information may indicate two or more picture partitioning methods. The picture partitioning methods may be changed either periodically or according to a specific rule. The picture partition information may describe such a periodic change or the specified rule.

### TECHNICAL FIELD

The following embodiments generally relate to a video decoding method and apparatus and a video encoding method and apparatus and, more particularly, to a method and apparatus for performing encoding and decoding on a video using picture partition information.

This application claims the benefit of Korean Patent Application Nos. 10-2016-0038461, filed Mar. 30, 2016 and 10-2017-0040439, filed Mar. 30, 2017, which are hereby incorporated by reference in their entirety into this application.

### BACKGROUND ART

With the continuous development of the information and communication industries, broadcasting services having High-Definition (HD) resolution have been popularized all over the world. Through this popularization, a large number of users have become accustomed to high-resolution and high-definition images and/or videos.

To satisfy users' demands for high definition, a large number of institutions have accelerated the development of next-generation imaging devices. Users' interest in Ultra High Definition (UHD) TVs, having resolution that is more than four times as high as that of Full HD (FHD) TVs, as well as High-Definition TVs (HDTV) and FHD TVs, has increased. As such interest has increased, image encoding/decoding technology for images having higher resolution and higher definition is required.

An image encoding/decoding apparatus and method may use inter prediction technology, intra prediction technology, entropy coding technology, etc. in order to perform encoding/decoding on high-resolution and high-definition images. Inter prediction technology may be a technique for predicting the value of a pixel included in a current picture using temporally previous pictures and/or temporally subsequent pictures. Intra prediction technology may be a technique for predicting the value of a pixel included in the current picture using information about pixels in the current picture. Entropy coding technology may be a technique for assigning short code to symbols that occur more frequently and assigning long code to symbols that occur less frequently.

In image encoding and decoding, prediction may mean the generation of a prediction signal similar to an original signal. Prediction may be chiefly classified into prediction that refers to a spatially reconstructed image, prediction that refers to a temporally reconstructed image, and prediction that refers to other symbols. In other words, temporal referencing may mean that a temporally reconstructed image is referred to, and spatial referencing may mean that a spatially reconstructed image is referred to.

The current block may be a block that is the target to be currently encoded or decoded. The current block may be referred to as a “target block” or “target unit”. In encoding, the current block may be referred to as an “encoding target block” or “encoding target unit”. In decoding, the current block may be referred to as a “decoding target block” or “decoding target unit”.

Inter prediction may be technology for predicting a current block using temporal referencing and spatial referencing. Intra prediction may be technology for predicting the current block using only spatial referencing.

When pictures constituting a video are encoded, each of the pictures may be partitioned into multiple parts, and the multiple parts may be encoded. In this case, in order for a decoder to decode the partitioned picture, information about the partitioning of the picture may be required.

### DISCLOSURE

### Technical Problem

An embodiment is intended to provide a method and apparatus that improve encoding efficiency and decoding efficiency using technology for performing adaptive encoding and decoding that use picture partition information.

An embodiment is intended to provide a method and apparatus that improve encoding efficiency and decoding efficiency using technology for performing encoding and decoding that determine picture partitioning for multiple pictures based on one piece of picture partition information.

An embodiment is intended to provide a method and apparatus that derive additional picture partition information from one piece of picture partition information for a bitstream encoded using two or more different pieces of picture partition information.

An embodiment is intended to provide a method and apparatus that omit the transmission or reception of picture partition information for at least some of pictures in a video.

### Technical Solution

In accordance with an aspect, there is provided a video encoding method, including performing encoding on multiple pictures; and generating data that includes picture partition information and the multiple encoded pictures, wherein each of the multiple pictures is partitioned using one of at least two different methods corresponding to the picture partition information.

In accordance with another aspect, there is provided a video decoding method, including a control unit for acquiring picture partition information; and a decoding unit for performing decoding on multiple pictures, wherein each of the multiple pictures is partitioned using one of at least two different methods based on the picture partition information.

In accordance with a further aspect, there is provided a video decoding method, including decoding picture partition information; and performing decoding on multiple pictures based on the picture partition information, wherein each of the multiple pictures is partitioned using one of at least two different methods.

A first picture of the multiple pictures may be partitioned based on the picture partition information.

A second picture of the multiple pictures may be partitioned based on additional picture partition information derived based on the picture partition information.

The multiple pictures may be partitioned using a picture partitioning method that is defined by the picture partition information and is periodically changed.

The multiple pictures may be partitioned using a picture partitioning method that is defined by the picture partition information and is changed according to a rule.

The picture partition information may indicate that an identical picture partitioning method is to be applied to pictures for which a remainder, obtained when a picture order count value of the pictures is divided by a first predefined value, is a second predefined value, among the multiple pictures.

The picture partition information may indicate a number of tiles into which each of the multiple pictures is to be partitioned.

Each of the multiple pictures may be partitioned into a number of tiles determined based on the picture partition information.

Each of the multiple pictures may be partitioned into a number of slices determined based on the picture partition information.

The picture partition information may be included in a Picture Parameter Set (PPS).

The PPS may include a unified partition indication flag indicating whether a picture referring to the PPS is partitioned using one of at least two different methods.

The picture partition information may indicate, for a picture at a specific level, a picture partitioning method corresponding to the picture.

The level may be a temporal level.

The picture partition information may include decrease indication information for decreasing a number of tiles generated from partitioning of each picture.

The decrease indication information may be configured to adjust a number of horizontal tiles when a picture horizontal length is greater than a picture vertical length and to adjust a number of vertical tiles when the picture vertical length is greater than the picture horizontal length.

The picture horizontal length may be a horizontal length of the picture.

The picture vertical length may be a vertical length of the picture.

The number of horizontal tiles may be a number of tiles arranged in a lateral direction of the picture.

The number of vertical tiles may be a number of tiles arranged in a longitudinal direction of the picture.

The picture partition information may include level n decrease indication information for decreasing a number of tiles generated from partitioning of a picture at level n.

The picture partition information may include decrease indication information for decreasing a number of slices generated from partitioning of each picture.

The picture partition information may include level n decrease indication information for decreasing a number of slices generated from partitioning of a picture at level n.

The at least two different methods may be different from each other for a number of slices generated from partitioning of each picture

### Advantageous Effects

Provided are a method and apparatus that improve encoding efficiency and decoding efficiency using technology for performing adaptive encoding and decoding that use picture partition information.

Provided are a method and apparatus that improve encoding efficiency and decoding efficiency using technology for performing encoding and decoding that determine picture partitioning for multiple pictures based on one piece of picture partition information.

Provided are a method and apparatus that derive additional picture partition information from one piece of picture partition information for a bitstream encoded using two or more different pieces of picture partition information.

Provided are a method and apparatus that omit the transmission or reception of picture partition information for at least some of pictures in a video.

### DESCRIPTION OF DRAWINGS

FIG. 1 is a block diagram illustrating the configuration of an embodiment of an encoding apparatus to which the present invention is applied;

FIG. 2 is a block diagram illustrating the configuration of an embodiment of a decoding apparatus to which the present invention is applied;

FIG. 3 is a diagram schematically illustrating the partition structure of an image when the image is encoded and decoded;

FIG. 4 is a diagram illustrating the form of a Prediction Unit (PU) that a Coding Unit (CU) can include;

FIG. 5 is a diagram illustrating the form of a Transform Unit (TU) that can be included in a CU;

FIG. 6 is a diagram for explaining an embodiment of an intra-prediction procedure;

FIG. 7 is a diagram for explaining an embodiment of an inter-prediction procedure;

FIG. 8 illustrates the partitioning of a picture that uses tiles according to an embodiment;

FIG. 9 illustrates a reference structure of encoding to which GOP levels are applied according to an embodiment;

FIG. 10 illustrates the encoding order of pictures in a GOP according to an embodiment;

FIG. 11 illustrates the parallel encoding of pictures in a GOP according to an embodiment;

FIG. 12 illustrates the partitioning of a picture that uses slices according to an embodiment;

FIG. 13 is a configuration diagram of an encoding apparatus for performing video encoding according to an embodiment;

FIG. 14 is a flowchart of an encoding method for performing video encoding according to an embodiment;

FIG. 15 is a configuration diagram of a decoding apparatus for performing video decoding according to an embodiment;

FIG. 16 is a flowchart of a decoding method for performing video decoding according to an embodiment; and

FIG. 17 is a configuration diagram of an electronic device in which an encoding apparatus and/or a decoding apparatus are implemented according to an embodiment.

### BEST MODE

Detailed descriptions of the following exemplary embodiments will be made with reference to the attached drawings illustrating specific embodiments.

In the drawings, similar reference numerals are used to designate the same or similar functions in various aspects. The shapes, sizes, etc. of components in the drawings may be exaggerated to make the description clear.

It will be understood that when a component is referred to as being “connected” or “coupled” to another component, it can be directly connected or coupled to the other component, or intervening components may be present. Further, it should be noted that, in exemplary embodiments, the expression describing that a component “comprises” a specific component means that additional components may be included in the scope of the practice or the technical spirit of exemplary embodiments, but do not preclude the presence of components other than the specific component.

Respective components are arranged separately for convenience of description. For example, at least two of the components may be integrated into a single component. Conversely, one component may be divided into multiple components. An embodiment into which the components are integrated or an embodiment in which some components are separated is included in the scope of the present specification as long as it does not depart from the essence of the present specification.

Embodiments will be described in detail below with reference to the accompanying drawings so that those having ordinary knowledge in the technical field to which the embodiments pertain can easily practice the embodiments. In the following description of the embodiments, detailed descriptions of known functions or configurations which are deemed to make the gist of the present specification obscure will be omitted.

Hereinafter, “image” may mean a single picture constituting part of a video, or may mean the video itself. For example, “encoding and/or decoding of an image” may mean “encoding and/or decoding of a video”, and may also mean “encoding and/or decoding of any one of images constituting the video”.

Hereinafter, the terms “video” and “motion picture” may be used to have the same meaning, and may be used interchangeably with each other.

Hereinafter, the terms “image”, “picture”, “frame”, and “screen” may be used to have the same meaning and may be used interchangeably with each other.

In the following embodiments, specific information, data, a flag, an element, and an attribute may have their respective values. A value of 0 corresponding to each of the information, data, flag, element, and attribute may indicate a logical false or a first predefined value. In other words, a value of 0, a logical false, and a first predefined value may be used interchangeably with each other. A value of “1” corresponding to each of the information, data, flag, element, and attribute may indicate a logical true or a second predefined value. In other words, a value of “1”, a logical true, and a second predefined value may be used interchangeably with each other.

When a variable such as i or j is used to indicate a row, a column, or an index, the value of i may be an integer of 0 or more or an integer of 1 or more. In other words, in the embodiments, each of a row, a column, and an index may be counted from 0 or may be counted from 1.

Below, the terms to be used in embodiments will be described.

Unit: “unit” may denote the unit of image encoding and decoding. The meanings of the terms “unit” and “block” may be identical to each other. Further, the terms “unit” and “block” may be used interchangeably with each other.
Unit (or block) may be an M×N array of a sample. M and N may be positive integers, respectively. The term “unit” may generally mean a two-dimensional (2D) array of samples. The term “sample” may be either a pixel or a pixel value.
The term “pixel” and “sample” may be used to have the same meaning and may be used interchangeably with each other.
In the encoding and decoding of an image, “unit” may be an area generated by the partitioning of one image. A single image may be partitioned into multiple units. Upon encoding and decoding an image, processing predefined for each unit may be performed depending on the type of unit. Depending on the function, the types of unit may be classified into a macro unit, a Coding Unit (CU), a Prediction Unit (PU), and a Transform Unit (TU). A single unit may be further partitioned into lower units having a smaller size than that of the unit.
Unit partition information may include information about the depth of the unit. The depth information may indicate the number of times and/or the degree to which the unit is partitioned.
A single unit may be hierarchically partitioned into multiple lower units while having depth information based on a tree structure. In other words, the unit and lower units, generated by partitioning the unit, may correspond to a node and child nodes of the node, respectively. The individual partitioned lower units may have depth information. The depth information of the unit indicates the number of times and/or the degree to which the unit is partitioned, and thus the partition information of the lower units may include information about the sizes of the lower units.
In a tree structure, the top node may correspond to the initial node before partitioning. The top node may be referred to as a ‘root node’. Further, the root node may have a minimum depth value. Here, the top node may have a depth of level ‘0’.
A node having a depth of level ‘1’ may denote a unit generated when the initial unit is partitioned once. A node having a depth of level ‘2’ may denote a unit generated when the initial unit is partitioned twice.
A leaf node having a depth of level ‘n’ may denote a unit generated when the initial unit has been partitioned n times.
The leaf node may be a bottom node, which cannot be partitioned any further. The depth of the leaf node may be the maximum level. For example, a predefined value for the maximum level may be 3.
Transform Unit (TU): A TU may be the basic unit of residual signal encoding and/or residual signal decoding, such as transform, inverse transform, quantization, inverse quantization, transform coefficient encoding, and transform coefficient decoding. A single TU may be partitioned into multiple TUs, each having a smaller size.
Prediction Unit (PU): A PU may be a basic unit in the performance of prediction or compensation. The PU may be separated into multiple partitions via partitioning. The multiple partitions may also be basic units in the performance of prediction or compensation. The partitions generated via the partitioning of the PU may also be prediction units.
Reconstructed neighbor unit: A reconstructed neighbor unit may be a unit that has been previously encoded or decoded and reconstructed near an encoding target unit or a decoding target unit. The reconstructed neighbor unit may be either a unit spatially adjacent to the target unit or a unit temporally adjacent to the target unit.
Prediction unit partition: A prediction unit partition may mean a shape in which the PU is partitioned.
Parameter set: A parameter set may correspond to information about the header of the structure of a bitstream. For example, a parameter set may include a sequence parameter set, a picture parameter set, an adaptation parameter set, etc.
Rate-distortion optimization: An encoding apparatus may use rate-distortion optimization so as to provide higher encoding efficiency by utilizing combinations of the size of a CU, a prediction mode, the size of a prediction unit, motion information, and the size of a TU.
Rate-distortion optimization scheme: this scheme may calculate rate-distortion costs of respective combinations so as to select an optimal combination from among the combinations. The rate-distortion costs may be calculated using the following Equation 1. Generally, a combination enabling the rate-distortion cost to be minimized may be selected as the optimal combination in the rate-distortion optimization scheme.

D+λ*R [Equation 1]

Here, D may denote distortion. D may be the mean of squares of differences (mean square error) between original transform coefficients and reconstructed transform coefficients in a transform block.

R denotes the rate, which may denote a bit rate using related context information.

λ denotes a Lagrangian multiplier. R may include not only encoding parameter information, such as a prediction mode, motion information, and a coded block flag, but also bits generated due to the encoding of transform coefficients.

The encoding apparatus performs procedures such as inter-prediction and/or intra-prediction, transform, quantization, entropy coding, inverse quantization, and inverse transform, so as to calculate precise D and R, but those procedures may greatly increase the complexity of the encoding apparatus.
Reference picture: A reference picture may be an image used for inter-prediction or motion compensation. A reference picture may be a picture including a reference unit referred to by a target unit to perform inter-prediction or motion compensation. The terms “picture” and “image” may have the same meaning. Therefore, the terms “picture” and “image” may be used interchangeably with each other.
Reference picture list: A reference picture list may be a list including reference images used for inter-prediction or motion compensation. The types of reference picture lists may be a List Combined (LC), list 0 (L0), list 1 (L1), etc.
Motion Vector (MV): A MV may be a 2D vector used for inter-prediction. For example, a MV may be represented in a form such as (mvₓ, mv_{y}). Mvₓ may indicate a horizontal component and mv_{y} may indicate a vertical component.
MV may denote an offset between a target picture and a reference picture.
Search range: a search range may be a 2D area in which a search for a MV is performed during inter-prediction. For example, the size of the search range may be M×N. M and N may be positive integers, respectively.

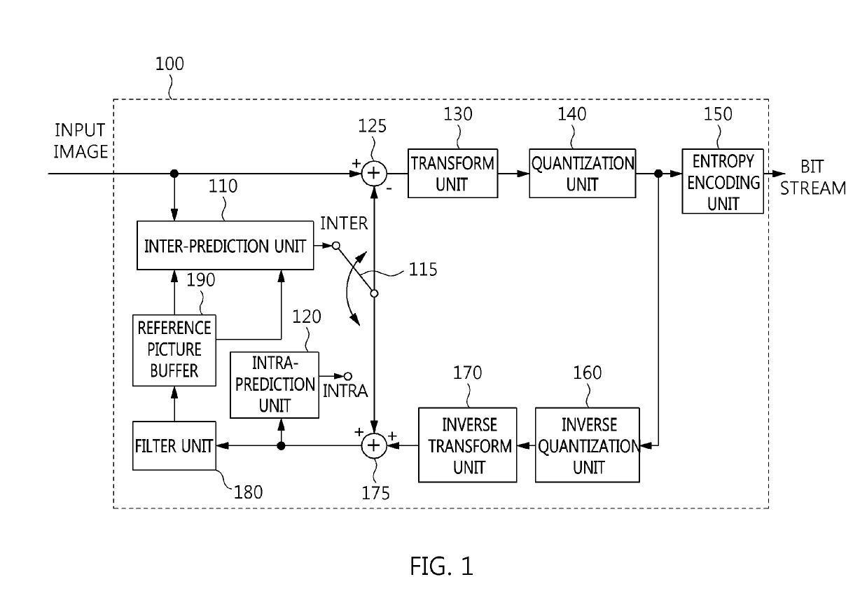

FIG. 1 is a block diagram illustrating the configuration of an embodiment of an encoding apparatus to which the present invention is applied.

An encoding apparatus 100 may be a video encoding apparatus or an image encoding apparatus. A video may include one or more images (pictures). The encoding apparatus 100 may sequentially encode one or more images of the video over time.

Referring to FIG. 1, the encoding apparatus 100 includes an inter-prediction unit 110, an intra-prediction unit 120, a switch 115, a subtractor 125, a transform unit 130, a quantization unit 140, an entropy decoding unit 150, an inverse quantization unit 160, an inverse transform unit 170, an adder 175, a filter unit 180, and a reference picture buffer 190.

The encoding apparatus 100 may perform encoding on an input image in an intra mode and/or an inter mode. The input image may be called a ‘current image’, which is the target to be currently encoded.

Further, the encoding apparatus 100 may generate a bitstream, including information about encoding, via encoding on the input image, and may output the generated bitstream.

When the intra mode is used, the switch 115 may switch to the intra mode. When the inter mode is used, the switch 115 may switch to the inter mode.

The encoding apparatus 100 may generate a prediction block for an input block in the input image. Further, after the prediction block has been generated, the encoding apparatus 100 may encode a residual between the input block and the prediction block. The input block may be called a ‘current block’, which is the target to be currently encoded.

When the prediction mode is an intra mode, the intra-prediction unit 120 may use pixel values of previously encoded neighboring blocks around a current block as reference pixels. The intra-prediction unit 120 may perform spatial prediction on the current block using the reference pixels and generate prediction samples for the current block via spatial prediction.

The inter-prediction unit 110 may include a motion prediction unit and a motion compensation unit.

When the prediction mode is an inter mode, the motion prediction unit may search a reference image for an area most closely matching the current block in a motion prediction procedure, and may derive a motion vector for the current block and the found area. The reference image may be stored in the reference picture buffer 190. More specifically, the reference image may be stored in the reference picture buffer 190 when the encoding and/or decoding of the reference image are processed.

The motion compensation unit may generate a prediction block by performing motion compensation using a motion vector. Here, the motion vector may be a two-dimensional (2D) vector used for inter-prediction. Further, the motion vector may indicate an offset between the current image and the reference image.

The subtractor 125 may generate a residual block which is the residual between the input block and the prediction block. The residual block is also referred to as a ‘residual signal’.

The transform unit 130 may generate a transform coefficient by transforming the residual block, and may output the generated transform coefficient. Here, the transform coefficient may be a coefficient value generated by transforming the residual block. When a transform skip mode is used, the transform unit 130 may omit transforming the residual block.

By applying quantization to the transform coefficient, a quantized transform coefficient level may be generated. Here, in the embodiments, the quantized transform coefficient level may also be referred to as a ‘transform coefficient’.

The quantization unit 140 may generate a quantized transform coefficient level by quantizing the transform coefficient depending on quantization parameters. The quantization unit 140 may output the quantized transform coefficient level. In this case, the quantization unit 140 may quantize the transform coefficient using a quantization matrix.

The entropy decoding unit 150 may generate a bitstream by performing probability distribution-based entropy encoding based on values, calculated by the quantization unit 140, and/or encoding parameter values, calculated in the encoding procedure. The entropy decoding unit 150 may output the generated bitstream.

The entropy decoding unit 150 may perform entropy encoding on information required to decode the image, in addition to the pixel information of the image. For example, the information required to decode the image may include syntax elements or the like.

The encoding parameters may be information required for encoding and/or decoding. The encoding parameters may include information encoded by the encoding apparatus and transferred to a decoding apparatus, and may also include information that may be derived in the encoding or decoding procedure. For example, information transferred to the decoding apparatus may include syntax elements.

For example, the encoding parameters may include values or statistical information, such as a prediction mode, a motion vector, a reference picture index, an encoding block pattern, the presence or absence of a residual signal, a transform coefficient, a quantized transform coefficient, a quantization parameter, a block size, and block partition information. The prediction mode may be an intra-prediction mode or an inter-prediction mode.

The residual signal may denote the difference between the original signal and a prediction signal. Alternatively, the residual signal may be a signal generated by transforming the difference between the original signal and the prediction signal. Alternatively, the residual signal may be a signal generated by transforming and quantizing the difference between the original signal and the prediction signal. The residual block may be a block-based residual signal.

When entropy encoding is applied, fewer bits may be assigned to more frequently occurring symbols, and more bits may be assigned to rarely occurring symbols. As symbols are represented by means of this assignment, the size of a bit string for target symbols to be encoded may be reduced. Therefore, the compression performance of video encoding may be improved through entropy encoding.

Further, for entropy encoding, a coding method such as exponential Golomb, Context-Adaptive Variable Length Coding (CAVLC), or Context-Adaptive Binary Arithmetic Coding (CABAC) may be used. For example, the entropy decoding unit 150 may perform entropy encoding using a Variable Length Coding/Code (VLC) table. For example, the entropy decoding unit 150 may derive a binarization method for a target symbol. Further, the entropy decoding unit 150 may derive a probability model for a target symbol/bin. The entropy decoding unit 150 may perform entropy encoding using the derived binarization method or probability model.

Since the encoding apparatus 100 performs encoding via inter-prediction, an encoded current image may be used as a reference image for additional image(s) to be subsequently processed. Therefore, the encoding apparatus 100 may decode the encoded current image and store the decoded image as a reference image. For decoding, inverse quantization and inverse transform on the encoded current image may be processed.

The quantized coefficient may be inversely quantized by the inverse quantization unit 160, and may be inversely transformed by the inverse transform unit 170. The coefficient that has been inversely quantized and inversely transformed may be added to the prediction block by the adder 175. The inversely quantized and inversely transformed coefficient and the prediction block are added, and then a reconstructed block may be generated.

The reconstructed block may undergo filtering through the filter unit 180. The filter unit 180 may apply one or more of a deblocking filter, a Sample Adaptive Offset (SAO) filter, and an Adaptive Loop Filter (ALF) to the reconstructed block or a reconstructed picture. The filter unit 180 may also be referred to as an ‘adaptive in-loop filter’.

The deblocking filter may eliminate block distortion occurring at the boundaries of blocks. The SAO filter may add a suitable offset value to a pixel value so as to compensate for a coding error. The ALF may perform filtering based on the result of comparison between the reconstructed block and the original block. The reconstructed block, having undergone filtering through the filter unit 180, may be stored in the reference picture buffer 190.

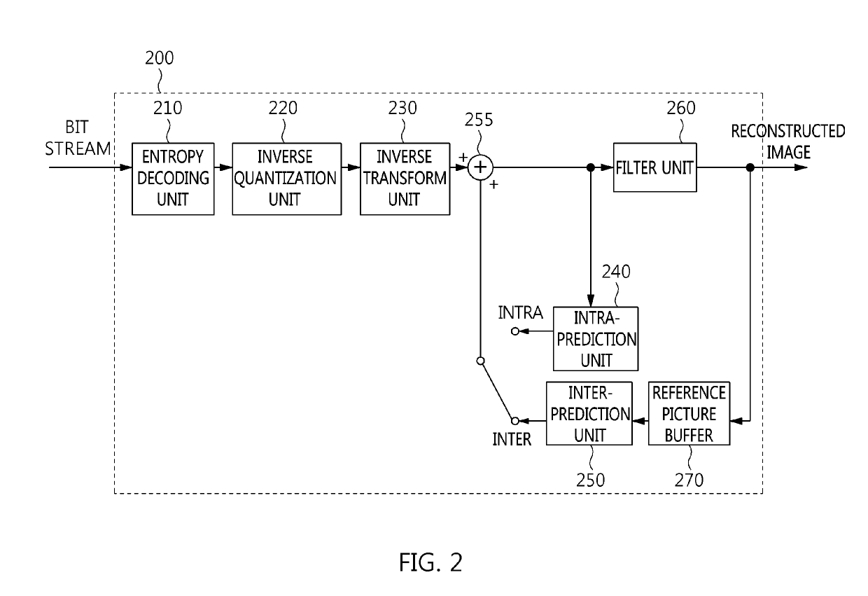

FIG. 2 is a block diagram illustrating the configuration of an embodiment of a decoding apparatus to which the present invention is applied.

A decoding apparatus 200 may be a video decoding apparatus or an image decoding apparatus.

Referring to FIG. 2, the decoding apparatus 200 may include an entropy decoding unit 210, an inverse quantization unit 220, an inverse transform unit 230, an intra-prediction unit 240, an inter-prediction unit 250, an adder 255, a filter unit 260, and a reference picture buffer 270.

The decoding apparatus 200 may receive a bitstream output from the encoding apparatus 100. The decoding apparatus 200 may perform decoding on the bitstream in an intra mode and/or an inter mode. Further, the decoding apparatus 200 may generate a reconstructed image via decoding and may output the reconstructed image.

For example, switching to an intra mode or an inter mode based on the prediction mode used for decoding may be performed by a switch. When the prediction mode used for decoding is an intra mode, the switch may be operated to switch to the intra mode. When the prediction mode used for decoding is an inter mode, the switch may be operated to switch to the inter mode.

The decoding apparatus 200 may acquire a reconstructed residual block from the input bitstream, and may generate a prediction block. When the reconstructed residual block and the prediction block are acquired, the decoding apparatus 200 may generate a reconstructed block by adding the reconstructed residual block to the prediction block.

The entropy decoding unit 210 may generate symbols by performing entropy decoding on the bitstream based on probability distribution. The generated symbols may include quantized coefficient-format symbols. Here, the entropy decoding method may be similar to the above-described entropy encoding method. That is, the entropy decoding method may be the reverse procedure of the above-described entropy encoding method.

The quantized coefficient may be inversely quantized by the inverse quantization unit 220. Further, the inversely quantized coefficient may be inversely transformed by the inverse transform unit 230. As a result of inversely quantizing and inversely transforming the quantized coefficient, a reconstructed residual block may be generated. Here, the inverse quantization unit 220 may apply a quantization matrix to the quantized coefficient.

When the intra mode is used, the intra-prediction unit 240 may generate a prediction block by performing spatial prediction using the pixel values of previously decoded neighboring blocks around a current block.

The inter-prediction unit 250 may include a motion compensation unit. When the inter mode is used, the motion compensation unit may generate a prediction block by performing motion compensation, which uses a motion vector and reference images. The reference images may be stored in the reference picture buffer 270.

The reconstructed residual block and the prediction block may be added to each other by the adder 255. The adder 255 may generate a reconstructed block by adding the reconstructed residual block to the prediction block.

The reconstructed block may undergo filtering through the filter unit 260. The filter unit 260 may apply one or more of a deblocking filter, an SAO filter, and an ALF to the reconstructed block or the reconstructed picture. The filter unit 260 may output the reconstructed image (picture). The reconstructed image may be stored in the reference picture buffer 270 and may then be used for inter-prediction.

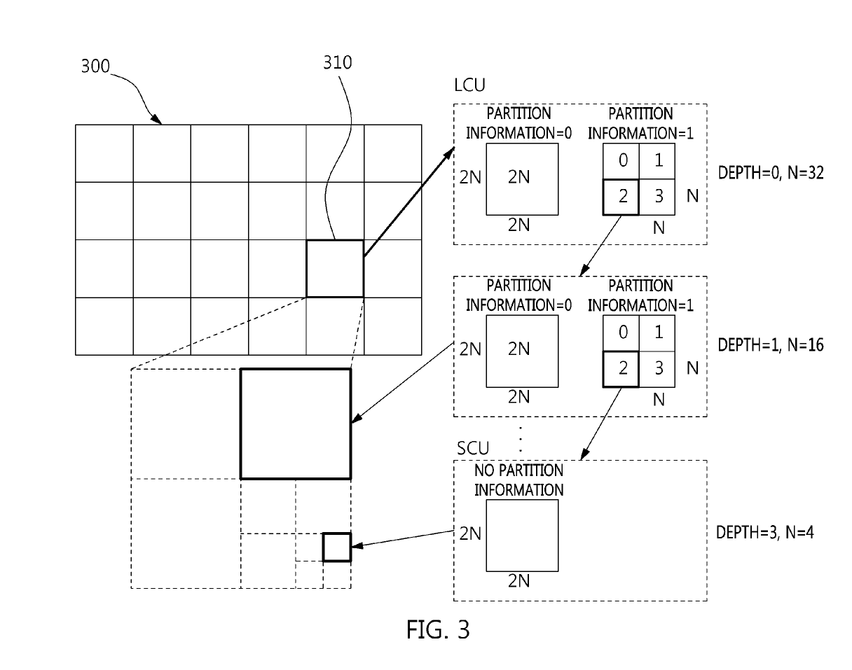

FIG. 3 is a diagram schematically illustrating an image partition structure when the image is encoded and decoded.

In order to efficiently partition the image, a Coding Unit (CU) may be used in encoding and decoding. The term “unit” may be used to collectively designate 1) a block including image samples and 2) a syntax element. For example, the “partitioning of a unit” may mean the “partitioning of a block corresponding to a unit”.

Referring to FIG. 3, an image 200 may be sequentially partitioned into units corresponding to a Largest Coding Unit (LCU), and the partition structure of the image 300 may be determined according to the LCU. Here, the LCU may be used to have the same meaning as a Coding Tree Unit (CTU).

The partition structure may mean the distribution of Coding Units (CUs) to efficiently encode the image in an LCU 310. Such a distribution may be determined depending on whether a single CU is to be partitioned into four CUs. The horizontal size and the vertical size of each of CUs generated from the partitioning may be half the horizontal size and the vertical size of a CU before being partitioned. Each partitioned CU may be recursively partitioned into four CUs, the horizontal size and the vertical size of which are halved in the same way.

Here, the partitioning of a CU may be recursively performed up to a predefined depth. Depth information may be information indicative of the size of a CU. Depth information may be stored for each CU. For example, the depth of an LCU may be 0, and the depth of a Smallest Coding Unit (SCU) may be a predefined maximum depth. Here, as described above, the LCU may be a CU having the maximum coding unit size, and the SCU may be a CU having the minimum coding unit size.

Partitioning may start at the LCU 310, and the depth of a CU may be increased by 1 whenever the horizontal and vertical sizes of the CU are halved by partitioning. For respective depths, a CU that is not partitioned may have a size of 2N×2N. Further, in the case of a CU that is partitioned, a CU having a size of 2N×2N may be partitioned into four CUs, each having a size of N×N. The size of N may be halved whenever the depth is increased by 1.

Referring to FIG. 3, an LCU having a depth of 0 may have 64×64 pixels. 0 may be a minimum depth. An SCU having a depth of 3 may have 8×8 pixels. 3 may be a maximum depth. Here, a CU having 64×64 pixels, which is the LCU, may be represented by a depth of 0. A CU having 32×32 pixels may be represented by a depth of 1. A CU having 16×16 pixels may be represented by a depth of 2. A CU having 8×8 pixels, which is the SCU, may be represented by a depth of 3.

Further, information about whether the corresponding CU is partitioned may be represented by the partition information of the CU. The partition information may be 1-bit information. All CUs except the SCU may include partition information. For example, when a CU is not partitioned, the value of the partition information of the CU may be 0. When a CU is partitioned, the value of the partition information of the CU may be 1.

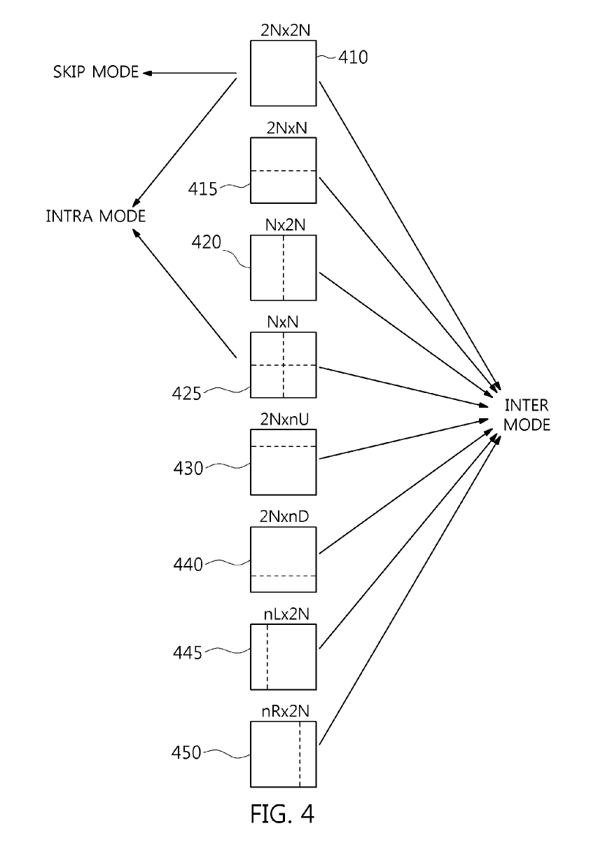

FIG. 4 is a diagram illustrating the form of a Prediction Unit (PU) that a Coding Unit (CU) can include.

When, among CUs partitioned from an LCU, a CU, which is not partitioned any further, may be divided into one or more Prediction Units (PUs). Such a division is also referred to as “partitioning”.

A PU may be a basic unit for prediction. A PU may be encoded and decoded in any one of a skip mode, an inter mode, and an intra mode. A PU may be partitioned into various shapes depending on respective modes.

In a skip mode, partitioning may not be present in a CU. In the skip mode, a 2N×2N mode 410, in which the sizes of a PU and a CU are identical to each other, may be supported without partitioning.

In an inter mode, 8 types of partition shapes may be present in a CU. For example, in the inter mode, the 2N×2N mode 410, a 2N×N mode 415, an N×2N mode 420, an N×N mode 425, a 2N×nU mode 430, a 2N×nD mode 435, an nL×2N mode 440, and an nR×2N mode 445 may be supported.

In an intra mode, the 2N×2N mode 410 and the N×N mode 425 may be supported.

In the 2N×2N mode 410, a PU having a size of 2N×2N may be encoded. The PU having a size of 2N×2N may mean a PU having a size identical to that of the CU. For example, the PU having a size of 2N×2N may have a size of 64×64, 32×32, 16×16 or 8×8.

In the N×N mode 425, a PU having a size of N×N may be encoded.

For example, in intra prediction, when the size of a PU is 8×8, four partitioned PUs may be encoded. The size of each partitioned PU may be 4×4.

When a PU is encoded in an intra mode, the PU may be encoded using any one of multiple intra-prediction modes. For example, HEVC technology may provide 35 intra-prediction modes, and the PU may be encoded in any one of the 35 intra-prediction modes.

Which one of the 2N×2N mode 410 and the N×N mode 425 is to be used to encode the PU may be determined based on rate-distortion cost.

The encoding apparatus 100 may perform an encoding operation on a PU having a size of 2N×2N. Here, the encoding operation may be the operation of encoding the PU in each of multiple intra-prediction modes that can be used by the encoding apparatus 100. Through the encoding operation, the optimal intra-prediction mode for a PU having a size of 2N×2N may be derived. The optimal intra-prediction mode may be an intra-prediction mode in which a minimum rate-distortion cost occurs upon encoding the PU having a size of 2N×2N, among multiple intra-prediction modes that can be used by the encoding apparatus 100.

Further, the encoding apparatus 100 may sequentially perform an encoding operation on respective PUs obtained from N×N partitioning. Here, the encoding operation may be the operation of encoding a PU in each of multiple intra-prediction modes that can be used by the encoding apparatus 100. By means of the encoding operation, the optimal intra-prediction mode for the PU having an N×N size may be derived. The optimal intra-prediction mode may be an intra-prediction mode in which a minimum rate-distortion cost occurs upon encoding the PU having a size of N×N, among multiple intra-prediction modes that can be used by the encoding apparatus 100.

The encoding apparatus 100 may determine which one of the PU having a size of 2N×2N and PUs having a size of N×N is to be encoded based on the result of a comparison between the rate-distortion cost of the PU having a size of 2N×2N and the rate-distortion costs of PUs having a size of N×N.

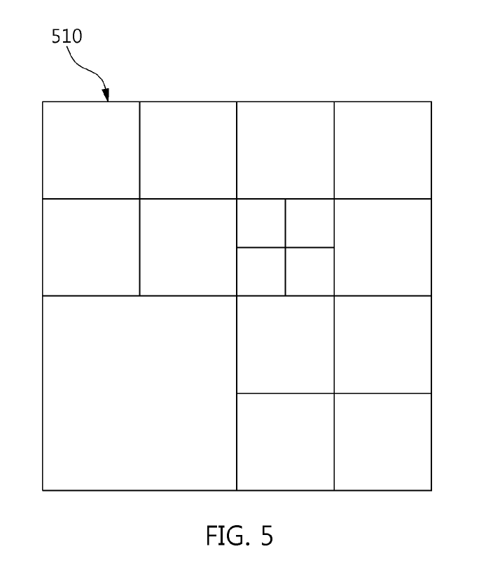

FIG. 5 is a diagram illustrating the form of a Transform Unit (TU) that can be included in a CU.

A Transform Unit (TU) may have a basic unit that is used for a procedure, such as transform, quantization, inverse transform, inverse quantization, entropy encoding, and entropy decoding, in a CU. A TU may have a square shape or a rectangular shape.

Among CUs partitioned from the LCU, a CU which is not partitioned into CUs any further may be partitioned into one or more TUs. Here, the partition structure of a TU may be a quad-tree structure. For example, as shown in FIG. 5, a single CU 510 may be partitioned one or more times depending on the quad-tree structure. By means of this partitioning, the single CU 510 may be composed of TUs having various sizes.

In the encoding apparatus 100, a Coding Tree Unit (CTU) having a size of 64×64 may be partitioned into multiple smaller CUs by a recursive quad-tree structure. A single CU may be partitioned into four CUs having the same size. Each CU may be recursively partitioned and may have a quad-tree structure.

A CU may have a given depth. When the CU is partitioned, CUs resulting from partitioning may have a depth increased from the depth of the partitioned CU by 1.

For example, the depth of a CU may have a value ranging from 0 to 3. The size of the CU may range from a size of 64×64 to a size of 8×8 depending on the depth of the CU.

By the recursive partitioning of a CU, an optimal partitioning method that incurs a minimum rate-distortion cost may be selected.

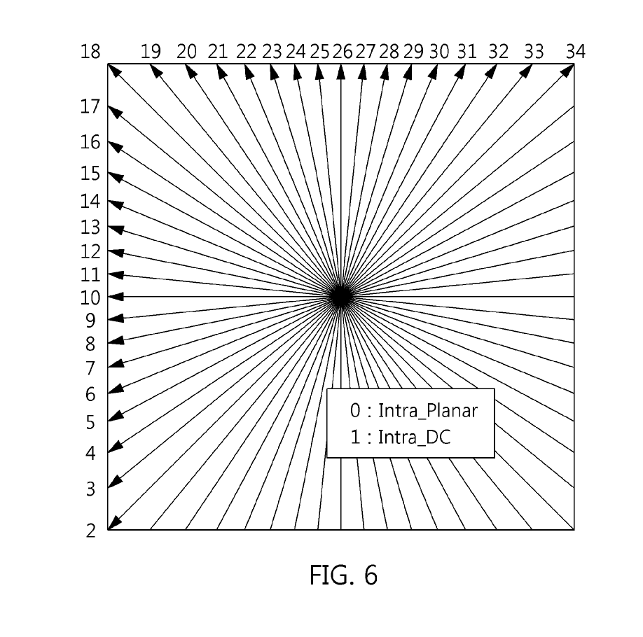

FIG. 6 is a diagram for explaining an embodiment of an intra-prediction process.

Arrows radially extending from the center of a graph in FIG. 6 may indicate the prediction directions of intra-prediction modes. Further, numbers indicated near the arrows may indicate examples of mode values assigned to intra-prediction modes or to the prediction directions of the intra-prediction modes.

Intra encoding and/or decoding may be performed using reference samples of units neighboring a target unit. The neighboring units may be neighboring reconstructed units. For example, intra encoding and/or decoding may be performed using the values of reference samples which are included in each neighboring reconstructed unit, or the encoding parameters of the neighboring reconstructed unit.

The encoding apparatus 100 and/or the decoding apparatus 200 may generate a prediction block by performing intra prediction on a target unit based on information about samples in a current picture. When intra prediction is performed, the encoding apparatus 100 and/or the decoding apparatus 200 may generate a prediction block for the target unit by performing intra prediction based on information about samples in a current picture. When intra prediction is performed, the encoding apparatus 100 and/or the decoding apparatus 200 may perform directional prediction and/or non-directional prediction based on at least one reconstructed reference sample.

A prediction block may mean a block generated as a result of performing intra prediction. A prediction block may correspond to at least one of a CU, a PU, and a TU.

The unit of a prediction block may have a size corresponding to at least one of a CU, a PU, and a TU. The prediction block may have a square shape having a size of 2N×2N or N×N. The size of N×N may include a size of 4×4, 8×8, 16×16, 32×32, 64×64, or the like.

Alternatively, a prediction block may be either a square block having a size of 2×2, 4×4, 16×16, 32×32, 64×64, or the like, or a rectangular block having a size of 2×8, 4×8, 2×16, 4×16, 8×16, or the like.

Intra prediction may be performed depending on an intra-prediction mode for a target unit. The number of intra-prediction modes which the target unit can have may be a predefined fixed value, and may be a value determined differently depending on the attributes of a prediction block. For example, the attributes of the prediction block may include the size of the prediction block, the type of prediction block, etc.

For example, the number of intra-prediction modes may be fixed at 35 regardless of the size of a prediction unit. Alternatively, the number of intra-prediction modes may be, for example, 3, 5, 9, 17, 34, 35, or 36.

The intra-prediction modes may include two non-directional modes and 33 directional modes, as shown in FIG. 6. The two non-directional modes may include a DC mode and a planar mode.

For example, in a vertical mode having a mode value of 26, prediction may be performed in a vertical direction based on the pixel value of a reference sample. For example, in a horizontal mode having a mode value of 10, prediction may be performed in a horizontal direction based on the pixel value of a reference sample.

Even in the directional modes other than the above-described mode, the encoding apparatus 100 and the decoding apparatus 200 may perform intra prediction on a target unit using reference samples depending on angles corresponding to the directional modes.

Intra-prediction modes located on a right side with respect to the vertical mode may be referred to as ‘vertical-right modes’. Intra-prediction modes located below the horizontal mode may be referred to as ‘horizontal-below modes’. For example, in FIG. 6, the intra-prediction modes in which a mode value is one of 27, 28, 29, 30, 31, 32, 33, and 34 may be vertical-right modes 613. Intra-prediction modes in which a mode value is one of 2, 3, 4, 5, 6, 7, 8, and 9 may be horizontal-below modes 616.

The non-directional modes may include a DC mode and a planar mode. For example, the mode value of the DC mode may be 1. The mode value of the planar mode may be 0.

The directional modes may include an angular mode. Among multiple intra-prediction modes, modes other than the DC mode and the planar mode may be the directional modes.

In the DC mode, a prediction block may be generated based on the average of pixel values of multiple reference samples. For example, the pixel value of the prediction block may be determined based on the average of pixel values of multiple reference samples.

The number of above-described intra-prediction modes and the mode values of respective intra-prediction modes are merely exemplary. The number of above-described intra-prediction modes and the mode values of respective intra-prediction modes may be defined differently depending on embodiments, implementation and/or requirements.

The number of intra-prediction modes may differ depending on the type of color component. For example, the number of prediction modes may differ depending on whether a color component is a luminance (luma) signal or a chrominance (chroma) signal.

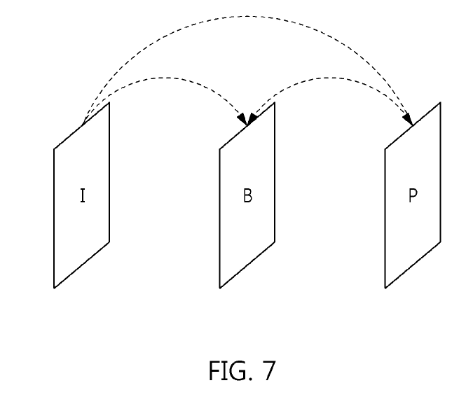

FIG. 7 is a diagram for explaining an embodiment of an inter prediction process.

The rectangles shown in FIG. 7 may represent images (or pictures). Further, in FIG. 7, arrows may represent prediction directions. That is, each image may be encoded and/or decoded depending on a prediction direction.

Images (or pictures) may be classified into an Intra Picture (I picture), a Uni-prediction Picture or Predictive Coded Picture (P picture), and a Bi-prediction Picture or Bi-predictive coded Picture (B picture) depending on the encoding type. Each picture may be encoded depending on the encoding type thereof.

When an image that is the target to be encoded is an I picture, the image itself may be encoded without inter prediction. When an image that is the target to be encoded is a P picture, the image may be encoded via inter prediction, which uses reference pictures only in a forward direction. When an image that is the target to be encoded is a B picture, the image may be encoded via inter prediction, which uses reference pictures both in a forward direction and in a backward direction, and may also be encoded via inter prediction, which uses reference pictures in one of the forward direction and the backward direction.

The P picture and the B picture that are encoded and/or decoded using reference pictures may be regarded as images in which inter prediction is used.

Below, inter prediction in an inter mode according to an embodiment will be described in detail.

In an inter mode, the encoding apparatus 100 and the decoding apparatus 200 may perform prediction and/or motion compensation on an encoding target unit and a decoding target unit. For example, the encoding apparatus 100 or the decoding apparatus 200 may perform prediction and/or motion compensation by using the motion information of neighboring reconstructed units as the motion information of the encoding target unit or the decoding target unit. Here, the encoding target unit or the decoding target unit may mean a prediction unit and/or a prediction unit partition.

Inter prediction may be performed using a reference picture and motion information. Further, inter prediction may use the above-described skip mode.

A reference picture may be at least one of pictures previous or subsequent to a current picture. Here, inter prediction may perform prediction on a block in the current picture based on the reference picture. Here, the reference picture may mean an image used for the prediction of a block.

Here, a region in the reference picture may be specified by utilizing a reference picture index refldx, which indicates the reference picture, and a motion vector, which will be described later.

Inter prediction may select a reference picture and a reference block corresponding to the current block from the reference picture, and may generate a prediction block for the current block using the selected reference block. The current block may be a block that is the target to be currently encoded or decoded, among blocks in the current picture.

Motion information may be derived by each of the encoding apparatus 100 and the decoding apparatus 200 during inter prediction. Further, the derived motion information may be used to perform inter prediction.

Here, the encoding apparatus 100 and the decoding apparatus 200 may improve encoding efficiency and/or decoding efficiency by using the motion information of a neighboring reconstructed block and/or the motion information of a collocated block (col block). The col block may be the block corresponding to the current block in a collocated picture (col picture) that has been reconstructed in advance.

The neighboring reconstructed block may be a block present in the current picture and may be a block that has been reconstructed in advance via encoding and/or decoding. The reconstructed block may be a neighboring block adjacent to the current block and/or a block located at a corner outside the current block. Here, “block located at the corner outside the current block” may mean either a block vertically adjacent to a neighboring block that is horizontally adjacent to the current block, or a block horizontally adjacent to a neighboring block that is vertically adjacent to the current block.

For example, the neighboring reconstructed unit (block) may be a unit located to the left of the target unit, a unit located above the target unit, a unit located at the below-left corner of the target unit, a unit located at the above-right corner of the target unit, or a unit located at the above-left corner of the target unit.

Each of the encoding apparatus 100 and the decoding apparatus 200 may determine the block that is present at the location spatially corresponding to the current block in a col picture, and may determine a predefined relative location based on the determined block. The predefined relative location may be a location inside and/or outside the block present at the location spatially corresponding to the current block. Further, each of the encoding apparatus 100 and the decoding apparatus 200 may derive a col block based on the predefined relative location that has been determined. Here, a col picture may be any one picture, among one or more reference pictures included in a reference picture list.

The block in the reference picture may be present at the location spatially corresponding to the location of the current block in the reconstructed reference picture. In other words, the location of the current block in the current picture and the location of the block in the reference picture may correspond to each other. Hereinafter, the motion information of the block included in the reference picture may be referred to as ‘temporal motion information’.

The method of deriving motion information may change depending on the prediction mode of the current block. For example, as a prediction mode to be applied for inter prediction, there may be an Advanced Motion Vector Predictor (AMVP) mode, a merge mode, etc.

For example, when the AMVP mode is applied as the prediction mode, each of the encoding apparatus 100 and the decoding apparatus 200 may generate a predictive motion vector candidate list using the motion vector of a neighboring reconstructed block and/or the motion vector of a col block. The motion vector of the neighboring reconstructed block and/or the motion vector of the col block may be used as predictive motion vector candidates.

A bitstream generated by the encoding apparatus 100 may include a predictive motion vector index. The predictive motion vector index may indicate the optimal predictive motion vector selected from among predictive motion vector candidates included in the predictive motion vector candidate list. The predictive motion vector index may be transmitted from the encoding apparatus 100 to the decoding apparatus 200 through the bitstream.

The decoding apparatus 200 may select the predictive motion vector of the current block from among the predictive motion vector candidates included in the predictive motion vector candidate list using the predictive motion vector index.

The encoding apparatus 100 may calculate a Motion Vector Difference (MVD) between the motion vector and the predictive motion vector of the current block, and may encode the MVD. The bitstream may include an encoded MVD. The MVD may be transmitted from the encoding apparatus 100 to the decoding apparatus 200 through the bitstream. Here, the decoding apparatus 200 may decode the received MVD. The decoding apparatus 200 may derive the motion vector of the current block using the sum of the decoded MVD and the predictive motion vector.

The bitstream may include a reference picture index for indicating a reference picture. The reference picture index may be transmitted from the encoding apparatus 100 to the decoding apparatus 200 through the bitstream. The decoding apparatus 200 may predict the motion vector of the current block using the motion information of neighboring blocks, and may derive the motion vector of the current block using the difference (MVD) between the predictive motion vector and the motion vector. The decoding apparatus 200 may generate a prediction block for the current block based on the derived motion vector and reference picture index information.

Since the motion information of neighboring reconstructed units may be used for the encoding target unit and the decoding target unit, the encoding apparatus 100 may not separately encode the motion information of the target unit in a specific inter-prediction mode. Unless the motion information of the target unit is encoded, the number of bits transmitted to the decoding apparatus 200 may be reduced, and encoding efficiency may be improved. For example, as inter-prediction modes in which the motion information of the target unit is not encoded, there may be a skip mode and/or a merge mode. Here, each of the encoding apparatus 100 and the decoding apparatus 200 may use an identifier and/or an index that indicate one of the neighboring reconstructed units, the motion information of which is to be used as the motion information of the target unit.

As another example of the method of deriving motion information, there is merging. The term “merging” may mean the merging of the motion of multiple blocks. The term “merging” may mean that the motion information of one block is also applied to other blocks. When merging is applied, each of the encoding apparatus 100 and the decoding apparatus 200 may generate a merge candidate list using the motion information of a neighboring reconstructed block and/or the motion information of a col block. The motion information may include at least one of 1) a motion vector, 2) an index for a reference image, and 3) a prediction direction. The prediction direction may be unidirectional or bidirectional.

Here, merging is applied on a CU basis or a PU basis. When merging is performed on a CU or PU basis, the encoding apparatus 100 may transmit predefined information to the decoding apparatus 200 through the bitstream. The bitstream may include predefined information. The predefined information may include 1) information about whether to perform merging for individual block partitions, and 2) information about a neighboring block with which merging is to be performed, among neighboring blocks adjacent to the current block. For example, the neighboring blocks of the current block may include the left-neighboring block of the current block, the above-neighboring block of the current block, the temporally neighboring block of the current block, etc.

The merge candidate list may denote a list in which pieces of motion information are stored. Further, the merge candidate list may be generated before merging is performed. The motion information stored in the merge candidate list may be 1) the motion information of neighboring blocks adjacent to the current block, and 2) the motion information of a collocated block, corresponding to the current block, in a reference image. Furthermore, the motion information stored in the merge candidate list may be new motion information generated by a combination of pieces of motion information present in advance in the merge candidate list.

A skip mode may be a mode in which information about neighboring blocks is applied to the current block without change. The skip mode may be one of the modes used for inter prediction. When the skip mode is used, the encoding apparatus 100 may transmit only information about a block, the motion information of which is to be used as the motion information of the current block, to the decoding apparatus 200 through a bitstream. The encoding apparatus 100 may not transmit other information to the decoding apparatus 200. For example, the other information may be syntax information. The syntax information may include Motion Vector Difference (MVD) information.

Partitioning of Picture that Uses Picture Partition Information

When pictures constituting a video are encoded, each of the pictures may be partitioned into multiple parts, and the multiple parts may be individually encoded. In this case, in order for the decoding apparatus to decode the partitioned picture, information about the partitioning of the picture may be required.

The encoding apparatus may transmit picture partition information indicating the partitioning of the picture to the decoding apparatus. The decoding apparatus may decode the picture using the picture partition information.

The header information of the picture may include picture partition information. Alternatively, the picture partition information may be included in the header information of the picture. The picture header information may be information that is applied to each of one or more pictures.

In one or more consecutive pictures, if the partitioning of pictures is changed, picture partition information indicating how each picture has been partitioned may be changed. When the picture partition information has changed upon processing multiple pictures, the encoding apparatus may transmit new picture partition information depending on the change to the decoding apparatus.

For example, a Picture Parameter Set (PPS) may include the picture partition information, and the encoding apparatus may transmit the PPS to the decoding apparatus. The PPS may include a PPS ID which is the identifier (ID) of the PPS. The encoding apparatus may notify the decoding apparatus which PPS is used for the picture through the PPS ID. The picture may be partitioned based on the picture partition information of the PPS.

In the encoding of a video, picture partition information for pictures constituting the video may be frequently and repeatedly changed. If the encoding apparatus must transmit new picture partition information to the decoding apparatus whenever picture partition information is changed, encoding efficiency and decoding efficiency may be deteriorated. Therefore, although picture partition information applied to each picture changes, encoding efficiency and decoding efficiency may be improved if the encoding, transmission, and decoding of the picture partition information can be omitted.

In the following embodiments, a method for deriving, for a bitstream of a video encoded using two or more pieces of picture partition information, additional picture partition information by using one piece of picture partition information will be described.

Since additional picture partition information is derived based on one piece of picture partition information, at least two different picture partitioning methods may be provided through other information containing one piece of picture partition information.

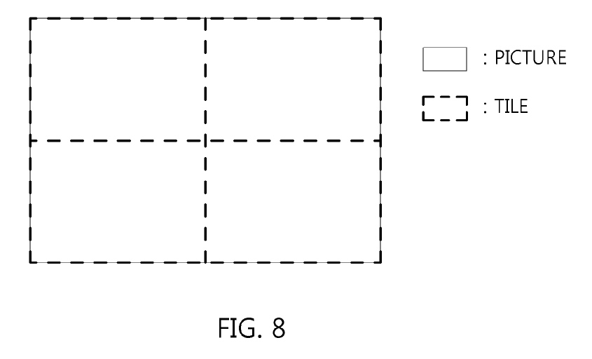

FIG. 8 illustrates the partitioning of a picture that uses tiles according to an embodiment.

In FIG. 8, a picture is indicated by a solid line, and tiles are indicated by dotted lines. The picture may be partitioned into multiple tiles.

Each tile may be one of entities used as the partition units of a picture. A tile may be the partition unit of a picture. Alternatively, a tile may be the unit of picture partitioning encoding.

Information about tiles may be signaled through a Picture Parameter Set (PPS). A PPS may contain information about tiles of a picture or information required in order to partition a picture into multiple tiles.

The following Table 1 shows an example of the structure of pic_parameter_set_rbsp. The picture partition information may be pic_parameter_set_rbsp or may include pic_parameter_set_rbsp.

TABLE 1

| pic_parameter_set_rbsp( ) { | Descriptor |
|---|---|
| ... | |
| tiles_enabled_flag | u(1) |
| if( tiles_enabled_flag ) { | |
| num_tile_columns_minus1 | ue(v) |
| num_tile_rows_minus1 | ue(v) |
| uniform_spacing_flag | u(1) |
| if( !uniform_spacing_flag ) { | |
| for( i = 0; i < num_tile_columns_minus1; i++ ) | |
| column_width_minus1[ i ] | ue(v) |
| for( i = 0; i < num_tile_rows_minus1; i++ ) | |
| row_height_minus1[ i ] | ue(v) |
| } | |
| } | |
| ... | |
| } | |

“pic_parameter_set_rbsp” may include the following elements.
tiles_enabled_flag: “tiles_enabled_flag” may be a tile presence indication flag that indicates whether one or more tiles are present in a picture that refers to the PPS.

For example, a tiles_enabled_flag value of “0” may indicate that no tiles are present in the picture that refers to the PPS. A tiles_enabled_flag value of “1” may indicate that one or more tiles are present in the picture that refers to the PPS.

The values of the tile presence indication flags tiles_enabled_flag of all activated PPSs in a single Coded Video Sequence (CVS) may be identical to each other.
num_tile_columns_minus1: “num_tile_columns_minus1” may be information about the number of column tiles corresponding to the number of tiles arranged in the lateral direction of a partitioned picture. For example, the value of “num_tile_columns_minus1+1” may denote the number of lateral tiles in the partitioned picture. Alternatively, the value of “num_tile_columns_minus1+1” may denote the number of tiles in one row.
num_tile_rows_minus1: “num_tile_rows_minus1” may be information about the number of row tiles corresponding to the number of tiles arranged in the longitudinal direction of the partitioned picture. For example, the value of “num_tile_rows_minus1+1” may denote the number of longitudinal tiles in the partitioned picture. Alternatively, “num_tile_row_minus1+1” may denote the number of tiles in one column.
uniform_spacing_flag: “uniform_spacing_flag” may be a uniform spacing indication flag that indicates whether a picture is equally partitioned into tiles in a lateral direction and a longitudinal direction. For example, uniform_spacing_flag may be a flag indicating whether the sizes of tiles in the picture are equal to each other. For example, a uniform_spacing_flag value of “0” may indicate that the picture is not equally partitioned in the lateral direction and/or a longitudinal direction. A uniform_spacing_flag value of “1” may indicate that the picture is equally partitioned in the lateral direction and the longitudinal direction. When the value of uniform_spacing_flag is “0”, elements that define in greater detail partitioning, such as column_width_minus1[i] and row_height_minus1[i], which will be described later, may be additionally required in order to partition the picture.
column_width_minus1 [i]: “column_width_minus1 [i]” may be tile width information corresponding to the width of a tile in an i-th column. Here, i may be an integer that is equal to or greater than 0 and is less than the number n of columns of tiles. For example, “column_width_minus1[i]+1” may denote the width of a tile in an i+1-th column. The width may be represented by a predefined unit. For example, the unit of width may be a Coding Tree Block (CTB).
row_height_minus1 [i]: “row_height_minus1 [i]” may be tile height information corresponding to the height of a tile in an i-th row. Here, i may be an integer that is equal to or greater than 0 and that is less than the number n of rows of tiles. For example, “row_height_minus1[i]+1” may denote the height of a tile in an i+1-th row. The height may be represented by a predefined unit. For example, the unit of height may be a Coding Tree Block (CTB).

In an example, picture partition information may be included in the PPS, and may be transmitted as a part of the PPS when the PPS is transmitted. The decoding apparatus may acquire picture partition information required in order to partition the picture by referring to the PPS of the picture.

In order to signal picture partition information differing from information that has been previously transmitted, the encoding apparatus may transmit a new PPS, which includes new picture partition information and a new PPS ID, to the decoding apparatus. Then, the encoding apparatus may transmit a slice header containing the PPS ID to the decoding apparatus.

Proposal of Method for Signaling Picture Partition Information Based on Tiles Changing According to Specific Rule

As described above, in a series of pictures, pieces of picture partition information applied to pictures may change. The retransmission of a new PPS may be required whenever the picture partition information changes.

In a series of pictures, pieces of picture partition information applied to pictures may be changed according to a specific rule. For example, the picture partition information may be periodically changed depending on the numbers of pictures.

When pieces of picture partition information are changed according to the specific rule, the transmission of the picture partition information may be omitted by utilizing such a rule. For example, the decoding apparatus may derive picture partition information for another picture from one piece of picture partition information that has been previously transmitted.

Typically, the pieces of picture partition information may not necessarily change for each picture, and may be repeated at regular periods and according to a specific rule.

For example, the partitioning of pictures may be performed in conformity with a parallel encoding policy. In order to perform parallel encoding on pictures, the encoding apparatus may partition each picture into tiles. The decoding apparatus may acquire a rule corresponding to the periodic change of picture partition information using information about the parallel encoding policy.

For example, when tiles are used as a picture partition tool, a periodically changing rule related to a method for partitioning a single picture into multiple tiles may be derived based on the information of the parallel encoding policy of the encoding apparatus.

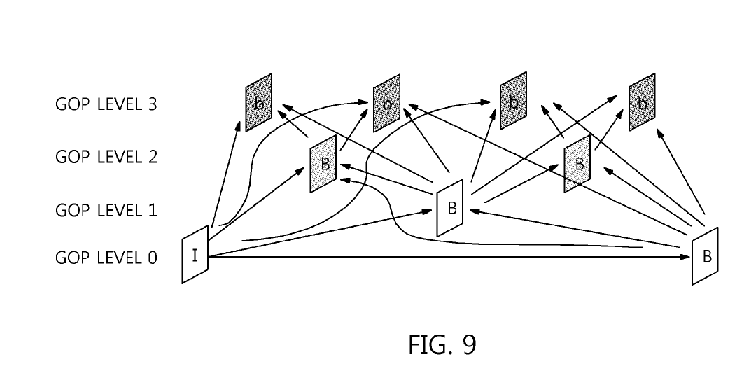

FIG. 9 illustrates a reference structure of encoding to which Group of Pictures (GOP) levels are applied according to an embodiment.

In FIG. 9, pictures constituting a GOP and a reference relationship between the pictures are illustrated.

When a sequence of pictures is encoded, a GOP may be applied. Random access to a video encoded through the GOP may be possible.

In FIG. 9, the size of the GOP is shown as being 8. For example, a single GOP may be a group of eight pictures.

In FIG. 9, each picture is shown as being a rectangle. “I”, “B” or “b” in each picture may denote the type of picture. The horizontal locations of the pictures may denote the temporal order of the pictures. The vertical locations of the pictures may denote the levels of the pictures. Here, “level” may be a temporal level. For example, the GOP level of each picture may correspond to the temporal level of the picture. Alternatively, the GOP level of the picture may be identical to the temporal level of the picture.

The GOP level of each picture may be determined by the Picture Order Count (POC) value of the picture. The GOP level of the picture may be determined by a remainder obtained when the POC value of the picture is divided by the size of the GOP. In other words, when the POC value of the picture is a multiple of 8 (8k), the GOP level of the picture may be 0. Here, k may be an integer of 0 or more. When the POC value of the picture is (8k+4), the GOP level of the picture may be 1. When the POC value of the picture is (8k+2) or (8k+6), the GOP level of the picture may be 2. When the POC value of the picture is (8k+1), (8k+3), (8k+5) or (8k+7), the GOP level of the picture may be 3.

In FIG. 9, pictures are divided by GOP levels ranging from GOP level 0 to GOP level 3. Arrows between the pictures may denote reference relationships between the pictures. For example, an arrow from a first I picture to a second b picture may represent that the first I picture is referred to by the second b picture.

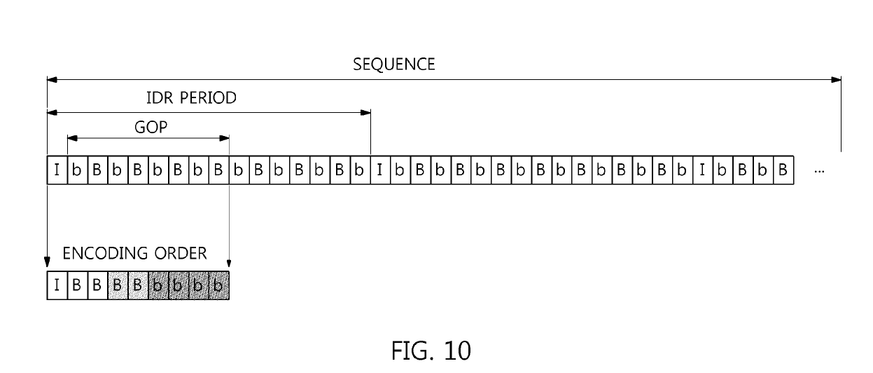

FIG. 10 illustrates the encoding order of pictures in a GOP according to an embodiment.

In FIG. 10, a sequence of pictures, an Instantaneous Decoder Refresh (IDR) period in the sequence, and a GOP are illustrated. Further, the encoding order of pictures in the GOP is illustrated.

In FIG. 10, uncolored pictures may be pictures at GOP level 0 or 1. Lightly colored pictures may be pictures at GOP level 2. Darkly colored pictures may be pictures at GOP level 3.

As shown in the drawing, the encoding order of pictures in the GOP may be determined in such a way that the type of pictures rather than the temporal order of pictures is applied by priority.

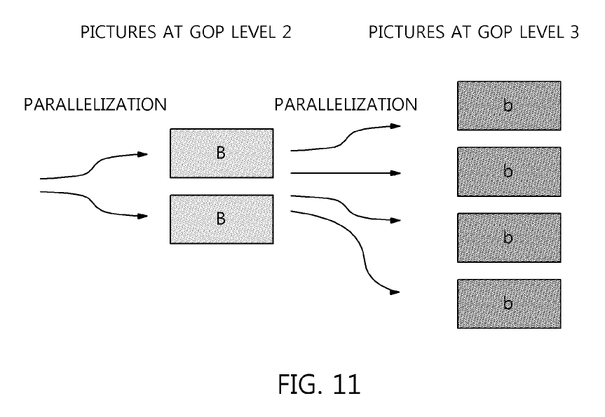

FIG. 11 illustrates parallel encoding of pictures in a GOP according to an embodiment.

In an embodiment, for pictures at GOP levels, such as those shown in FIG. 9, the encoding apparatus may encode the pictures using the combination of parallelization at the picture level and parallelization at the tile level.

Picture-level parallelization may mean that pictures do not refer to each other, and thus pictures, which can be encoded independently of each other, are encoded in parallel.

Tile-level parallelization may be parallelization related to the partitioning of pictures. Tile-level parallelization may mean that a single picture is partitioned into multiple tiles, and the multiple tiles are encoded in parallel.

Both picture-level parallelization and tile-level parallelization may be simultaneously applied to the parallelization of pictures. Alternatively, picture-level parallelization may be combined with tile-level parallelization.

For this parallelization, as shown in FIG. 9, a design may be made such that the remaining pictures at the same GOP levels other than pictures at GOP level 0, among the pictures in the GOP, do not refer to each other. That is, in FIG. 9, B pictures at GOP level 2 may not refer to each other, and b pictures at GOP level 3 may not refer to each other.

Under this design, a scheme may be devised which enables the remaining pictures other than pictures at GOP level 0, among pictures in the GOP, to be encoded in parallel. Since two pictures at GOP level 2 do not refer to each other, the two pictures at GOP level 2 may be encoded in parallel. Further, since four pictures at GOP level 3 do not refer to each other, the four pictures at GOP level 3 may be encoded in parallel.

Under such an encoding scenario, the numbers and shapes of partitions of the pictures may be allocated differently depending on the GOP levels of the pictures. The number of partitions of each picture may indicate the number of tiles or slices into which the picture is partitioned. The shape of partitions of the picture may denote the sizes and/or locations of respective tiles or slices.

In other words, the numbers and shapes of partitions of the pictures may be determined based on the GOP levels of the pictures. Each picture may be partitioned into a specific number of parts depending on the GOP level of the picture.

The GOP levels of the pictures and the partitions of the pictures may have a specific relationship. Pictures at the same GOP level may have the same picture partition information.

For example, when parallelization such as that shown in FIG. 11 is devised, if a picture at GOP level 0 and a picture at GOP level 1 are respectively partitioned into 4N parts, a picture at GOP level 2 may be partitioned into 2N parts, and a picture at GOP level 3 may be partitioned into N parts. Here, N may be an integer of 1 or more. According to this devisal, the number of threads for parts that are encoded in parallel when frame-level parallelization and picture-level parallelization are simultaneously used may be fixed. That is, when there is an additional picture that can be encoded or decoded in parallel with a specific picture, picture-level parallelization may be primarily performed, and tile-level parallelization for one picture may be performed to an extent inversely proportional to picture-level parallelization.

In an embodiment, there may be proposed a method in which picture partition information that changes either periodically or according to a specific rule is not transferred by several PPSs, and in which the changed picture partition information of other pictures is derived using picture partition information included in one PPS. Alternatively, one piece of picture partition information may indicate multiple picture partition shapes in which each picture is partitioned into different shapes.

For example, the picture partition information may indicate the number of pictures processed in parallel at each of specific GOP levels. The number of partitions of each picture may be acquired using the picture partition information.

Descriptions of GOP levels, made in relation to the partitioning of pictures in the above-described embodiments, may also be applied to a temporal identifier (temporal ID) or a temporal level. In other words, in the embodiments, “GOP level” may be replaced by “temporal level” or “temporal identifier”.

The temporal identifier may indicate the level in a hierarchical temporal prediction structure.

The temporal identifier may be contained in a Network Abstraction Layer (NAL) unit header.

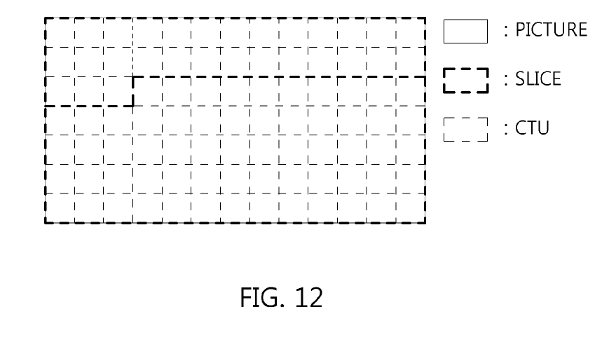

FIG. 12 illustrates the partitioning of a picture that uses slices according to an embodiment.

In FIG. 12, a picture is indicated by a solid line, slices are indicated by bold dotted lines, and Coding Tree Units (CPUs) are indicated by thin dotted lines. As shown in the drawing, the picture may be partitioned into multiple slices. One slice may be composed of one or more consecutive CTUs.

A slice may be one of entities that are used as the partition units of a picture. A slice may be the partition unit of the picture. Alternatively, a slice may be the unit of picture partitioning encoding.

Information about the slice may be signaled through a slice segment header. The slice segment header may contain information about slices.

When the slice is the unit of picture partitioning encoding, the picture partition information may define the start address of each of one or more slices.

The unit of the start address of each slice may be a CTU. The picture partition information may define the start CTU address of each of one or more slices. The partition shape of a picture may be defined by the start addresses of the slices.

The following Table 2 shows an example of the structure of slice_segment_header. The picture partition information may be slice_segment_header or may include slice_segment_header.

TABLE 2

| slice_segment_header ( ) { | Descriptor |
|---|---|
| ... | |
| first_slice_segment_in_pic_flag | u(1) |
| if( !first_slice_segment_in_pic_flag) { | |
| if( dependent_slice_segments_enabled_flag) | |
| dependent_slice_segment_flag | u(1) |
| slice_segment_address | u(v) |
| } | |
| ... | |
| } | |

“slice_segment_header” may include the following elements.
first_slice_segment_in_pic_flag: “first_slice_segment_in_pic_flag” may be a first slice indication flag that indicates whether a slice indicated by slice_segment_header is a first slice in a picture.

For example, a first_slice_segment_in_pic_flag value of “0” may indicate that the corresponding slice is not the first slice in the picture. A first_slice_segment_in_pic_flag value of “1” may indicate that the corresponding slice is the first slice in the picture.
dependent_slice_segment_flag: “dependent_slice_segment_flag” may be a dependent slice segment indication flag that indicates whether the slice indicated by slice_segment_header is a dependent slice.

For example, a dependent_slice_segment_flag value of “0” may indicate that the corresponding slice is not a dependent slice. A dependent_slice_segment_flag value of “1” may indicate that the corresponding slice is a dependent slice.

For example, a substream slice for Wavefront Parallel Processing; (WPP) may be a dependent slice. There may be an independent slice corresponding to the dependent slice. When a slice indicated by slice_segment_header is a dependent slice, at least one element of slice_segment_header may not be present. In other words, the values of elements in slice_segment_header may not be defined. For elements for which values in a dependent slice are not defined, the values of elements of an independent slice corresponding to the dependent slice may be used. In other words, the value of a specific element that is not present in the slice_segment_header of a dependent slice may be identical to the value of a specific element in the slice_segment_header of the independent slice corresponding to the dependent slice. For example, the dependent slice may inherit the values of elements in the independent slice corresponding thereto, and may redefine the values of at least some elements in the independent slice.
slice_segment_address: “slice_segment_address” may be start address information indicating the start address of a slice indicated by slice_segment_header. The unit of the start address information may be a CTB.

The methods for partitioning a picture into one or more slices may include the following methods 1) to 3).

Method 1): The first method may be a method for partitioning a picture by the maximum size of a bitstream that one slice can include.

Method 2): The second method may be a method for partitioning a picture by the maximum number of CTUs that one slice can include.

Method 3): The third method may be a method for partitioning a picture by the maximum number of tiles that one slice can include.

When the encoding apparatus intends to perform parallel encoding on a slice basis, the second method and the third method, among the three methods, may be typically used.

In the case of the first method, the size of a bitstream may be known after encoding has been completed, and thus it may be difficult to define slices to be processed in parallel before encoding starts. Therefore, the picture partitioning method that enables slice-based parallel encoding may be the second method, which uses the unit of the maximum number of CTUs, and the third method, which uses the unit of the maximum number of tiles.

When the second method and the third method are used, the partition size of the picture may be predefined before the picture is encoded in parallel. Further, depending on the defined size, slice_segment_address may be calculated. When the encoding apparatus uses a slice as the unit of parallel encoding, there is typically a tendency for slice_segment_address to be repeated at regular periods and/or depending on specific rules without changing for each picture.

Therefore, in an embodiment, a method for signaling picture partition information through parameters applied in common to pictures rather than signaling picture partition information for each slice may be used.

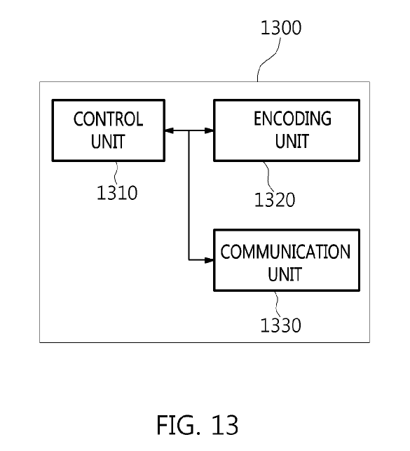

FIG. 13 is a configuration diagram of an encoding apparatus for performing video encoding according to an embodiment.

An encoding apparatus 1300 may include a control unit 1310, a decoding unit 1320, and a communication unit 1330.

The control unit 1310 may perform control for encoding of a video.

The decoding unit 1320 may perform encoding on the video.

The decoding unit 1320 may include the inter-prediction unit 110, the intra-prediction unit 120, the switch 115, the subtractor 125, the transform unit 130, the quantization unit 140, the entropy decoding unit 150, the inverse quantization unit 160, the inverse transform unit 170, the adder 175, the filter unit 180, and the reference picture buffer 190, which have been described above with reference to FIG. 1.

The communication unit 1330 may transmit data of an encoded video to another device.

Detailed functions and operations of the control unit 1310, the decoding unit 1320, and the communication unit 1330 will be described in greater detail below.

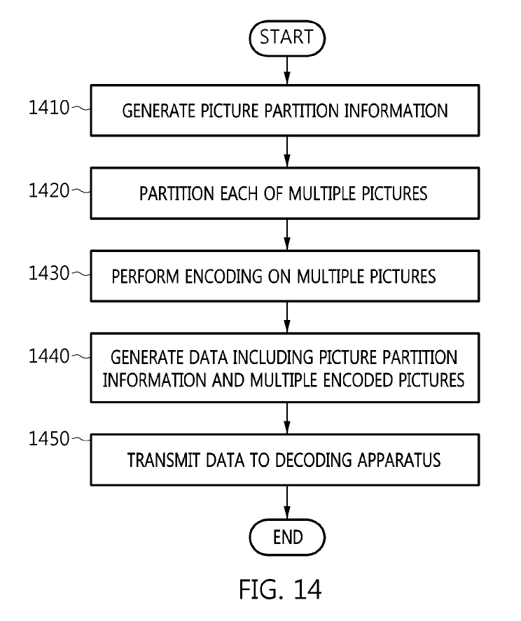

FIG. 14 is a flowchart of an encoding method for performing video encoding according to an embodiment.

At step 1410, the control unit 1310 may generate picture partition information about multiple pictures in the video. The picture partition information may indicate a picture partitioning method for each of the multiple pictures in the video.

For example, the picture partition information may indicate which method is to be used to partition each of the multiple pictures. The picture partition information may be applied to the multiple pictures. Further, when the multiple pictures are partitioned based on the picture partition information, methods for partitioning the multiple pictures may not be identical to each other. The partitioning methods may indicate the number of parts generated from partitioning, the shapes of the parts, the sizes of the parts, the widths of the parts, the heights of the parts, and/or the lengths of the parts.

For example, the picture partition information may indicate at least two different methods for partitioning pictures. The at least two different methods for partitioning pictures may be specified through the picture partition information. Further, the picture partition information may indicate which one of at least two different methods is to be used to partition each of the multiple pictures.

For example, multiple pictures may be pictures in a single GOP or pictures constituting a single GOP.

At step 1420, the control unit 1310 may partition each of the multiple pictures using one of the at least two different methods. The at least two different methods may correspond to the picture partition information. In other words, the picture partition information may specify at least two different methods for partitioning the multiple pictures.

Here, “different methods” may mean that the numbers, shapes, or sizes of parts generated from partitioning are different from each other. Here, the parts may be tiles or slices.

For example, the control unit 1310 may determine which one of the at least two different methods is to be used to partition each of the multiple pictures based on the picture partition information. The control unit 1310 may generate parts of the picture by partitioning the picture.

At step 1430, the decoding unit 1320 may perform encoding on multiple pictures that are partitioned based on the picture partition information. The decoding unit 1320 may perform encoding on each picture partitioned using one of the at least two different methods.

The parts of each picture may be individually encoded. The decoding unit 1320 may perform encoding on multiple parts, generated from the partitioning of the picture, in parallel.

At step 1440, the decoding unit 1320 may generate data including both the picture partition information and multiple encoded pictures. The data may be a bitstream.

At step 1450, the communication unit 1330 may transmit the generated data to the decoding apparatus.

The picture partition information and the parts of each picture will be described in greater detail with reference to other embodiments. Details of the picture partition information and the parts of each picture, which will be described in other embodiments, may also be applied to the present embodiment. Repeated descriptions thereof will be omitted.

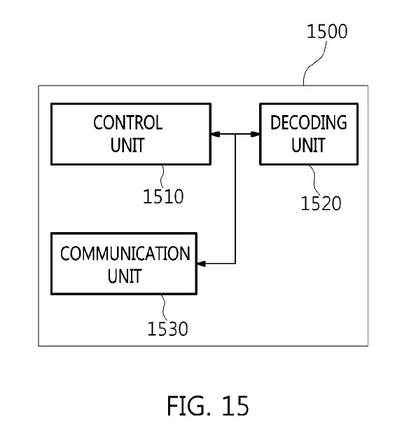

FIG. 15 is a configuration diagram of a decoding apparatus for performing video decoding according to an embodiment.

A decoding apparatus 1500 may include a control unit 1510, a decoding unit 1520, and a communication unit 1530.

The control unit 1510 may perform control for video encoding. For example, the control unit 1510 may acquire picture partition information from data or a bitstream. Alternatively, the control unit 1510 may decode the picture partition information in the data or the bitstream. Further, the control unit 1510 may control the decoding unit 1520 so that a video is decoded based on the picture partition information.

The decoding unit 1520 may perform decoding on the video.

The decoding unit 1520 may include the entropy decoding unit 210, the inverse quantization unit 220, the inverse transform unit 230, the intra-prediction unit 240, the inter-prediction unit 250, the adder 255, the filter unit 260, and the reference picture buffer 270, which have been described above with reference to FIG. 2.

The communication unit 1530 may receive data of an encoded video from another device.

The detailed functions and operations of the control unit 1510, the decoding unit 1520, and the communication unit 1530 will be described in greater detail below.

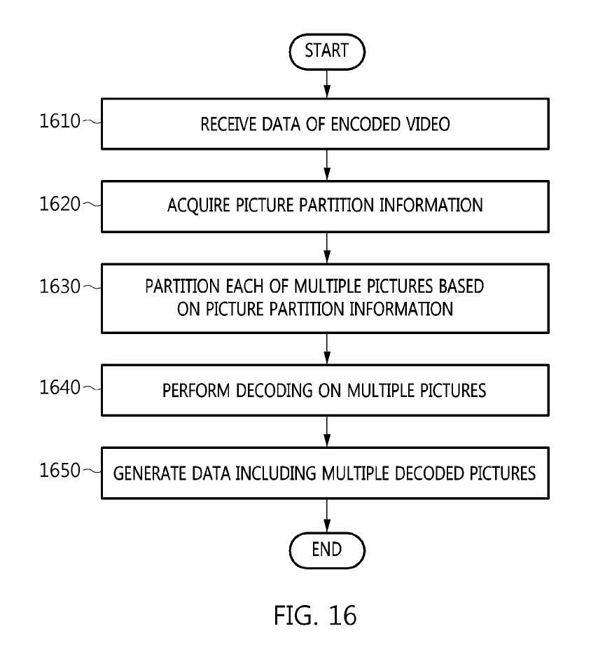

FIG. 16 is a flowchart of a decoding method for performing video decoding according to an embodiment.

At step 1610, the communication unit 1530 may receive data of an encoded video from the encoding apparatus 1300. The data may be a bitstream.

At step 1620, the control unit 1510 may acquire picture partition information from the data. The control unit 1510 may decode the picture partition information in the data, and may acquire the picture partition information via the decoding.

The picture partition information may indicate a picture partitioning method for each of multiple pictures in the video.

For example, the picture partition information may indicate which method is to be used to partition each of the multiple pictures. Further, when the multiple pictures are partitioned based on the picture partition information, methods for partitioning the multiple pictures may not be identical to each other.

The partitioning methods may indicate the numbers of parts generated from partitioning, the shapes of the parts, the sizes of the parts, the widths of the parts, the heights of the parts, and/or the lengths of the parts.

For example, the picture partition information may indicate at least two different methods for the partitioning of pictures. The at least two different methods for the partitioning of pictures may be specified through the picture partition information. Further, the picture partition information may indicate which one of at least two different methods is to be used to partition each of the multiple pictures based on the features or attributes of the pictures.

For example, the attributes of pictures may be the GOP levels, temporal identifiers or temporal levels of the pictures.

For example, the multiple pictures may be pictures in a single GOP, or pictures constituting a single GOP.

At step 1630, the control unit 1510 may partition each of the multiple pictures using one of at least two different methods based on the picture partition information. The control unit 1510 may determine which one of the at least two different methods is to be used to partition each of the multiple pictures based on the picture partition information. The control unit 1510 may generate parts of each picture by partitioning the picture.

The parts generated from partitioning may be tiles or slices.

For example, the control unit 1510 may partition a first picture of the multiple pictures based on the picture partition information. The control unit 1510 may partition the first picture depending on a first picture partitioning method indicated by the picture partition information. The control unit 1510 may partition a second picture of the multiple pictures based on other picture partition information derived from the picture partition information. The first picture and the second picture may be different pictures. For example, the GOP level of the first picture and the GOP level of the second picture may be different from each other. For example, at least some of one or more elements of the picture partition information may be used to derive other picture partition information from the picture partition information.

Alternatively, the control unit 1510 may partition the second picture depending on a second picture partitioning method derived from the picture partition information. At least some of the one or more elements of the picture partition information may indicate the first picture partitioning method. At least others of the one or more elements of the picture partition information may be used to derive the second picture partitioning method from the picture partition information or the first picture partitioning method.

The picture partition information may define a picture partitioning method which is periodically changed. The control unit 1510 may partition multiple pictures using the picture partitioning method which is defined by the picture partition information and which is periodically changed. In other words, specific picture partitioning methods may be repeatedly applied to a series of pictures. When the specific picture partitioning methods are applied to a specific number of pictures, the specific picture partitioning methods may be repeatedly applied to a subsequent specific number of pictures.

The picture partition information may define a picture partitioning method which is changed according to the rule. The control unit 1510 may partition multiple pictures using the picture partitioning method which is changed according to the rule and which is defined by the picture partition information. That is, picture partitioning methods specified according to the rule may be applied to a series of pictures.

At step 1640, the decoding unit 1520 may perform decoding on multiple pictures which are partitioned based on the picture partition information. The decoding unit 1520 may perform decoding on each picture partitioned using one of at least two different methods.

The parts of each picture may be individually decoded. The decoding unit 1520 may perform decoding on multiple parts, generated from the partitioning of each picture, in parallel.

At step 1650, the decoding unit 1520 may generate a video including the multiple decoded pictures.

As described above, the picture partition information may be defined by a PPS or by at least some elements of the PPS.

In an embodiment, the PPS may include picture partition information. That is, the PPS may include elements relevant to the picture partition information and elements not relevant to the picture partition information. The picture partition information may correspond to at least some elements of the PPS.

Alternatively, in an embodiment, the picture partition information may include PPS. That is, the picture partition information may be defined by the PPS and other information.

In an embodiment, the picture partition information used for multiple pictures may be defined by a single PPS rather than several PPSs. In other words, the picture partition information defined by a single PPS may be used to partition multiple pictures in at least two different shapes.

In an embodiment, picture partition information for a single picture may also be used to partition other pictures which are partitioned using a picture partitioning method differing from that of the picture. The picture partition information may include information required to derive other picture partitioning methods in addition to the information required to partition pictures in the PPS.

In this case, it may be understood that a piece of picture partition information indicates multiple picture partitioning methods applied to multiple pictures. For example, at least some elements of the picture partition information may define a first picture partitioning method. The first picture partitioning method may be applied to a first picture of the multiple pictures. At least other elements of the picture partition information may be used to derive a second picture partitioning method from the first picture partitioning method. The derived second picture partitioning method may be applied to a second picture of the multiple pictures. The picture partition information may contain information for defining a picture partitioning method to be applied and a picture to which the picture partitioning method is to be applied. That is, the picture partition information may contain information for specifying a picture partitioning method corresponding to each of the multiple pictures.

Alternatively, in an embodiment, a single PPS may include multiple pieces of picture partition information. The multiple pieces of picture partition information may be used to partition multiple pictures. In other words, in accordance with an embodiment, a PPS for a single picture may include picture partition information for partitioning other pictures as well as the picture partition information for partitioning the corresponding picture.

In this case, it may be understood that multiple pieces of picture partition information indicate multiple different picture partitioning methods, respectively, and may be transferred from the encoding apparatus to the decoding apparatus through a single PPS. For example, at least some elements of the PPS may define the picture partition information. The defined picture partition information may be applied to the first picture of the multiple pictures. At least other elements of the PPS may be used to derive other picture partition information from the defined picture partition information. The derived picture partition information may be applied to the second picture of the multiple pictures. The PPS may include information for defining picture partition information to be applied and a picture to which the picture partition information is to be applied. In other words, the PPS may include information for specifying picture partition information corresponding to each of multiple pictures.

Picture Partition Information for Partitioning Picture into Tiles

As described above, parts of a picture generated from partitioning may be tiles. The picture may be partitioned into multiple tiles.

The PPS may define parameters applied to a specified picture. At least some of the parameters may be picture partition information and may be used to determine a picture partitioning method.

In an embodiment, the picture partition information included in a single PPS may be applied to multiple pictures. Here, the multiple pictures may be partitioned using one of at least two different methods. That is, in order to define at least two different picture partitioning methods, a single PPS rather than several PPSs may be used.

Even if two pictures are partitioned using different picture partitioning methods, a PPS is not signaled for each picture, and a changed picture partitioning method may be derived by a single PPS or a single piece of picture partition information. For example, the PPS may include picture partition information to be applied to a single picture, and picture partition information to be applied to other pictures may be derived by the PPS. Alternatively, for example, the PPS may include picture partition information to be applied to a single picture, and picture partitioning methods to be applied to multiple pictures may be defined based on the picture partition information.

For example, the PPS may define the number of pictures to be processed in parallel for each GOP level. Once the number of pictures to be processed in parallel for each GOP level is defined, a picture partitioning method for a picture at specific GOP level may be determined. Alternatively, once the number of pictures to be processed in parallel for each GOP level is defined, the number of tiles into which the picture at the specific GOP level is to be partitioned may be determined.

For example, the PPS may define the number of pictures to be processed in parallel for each temporal identifier. Once the number of pictures to be processed in parallel for each temporal identifier is defined, a picture partitioning method for a picture having a specific temporal identifier may be determined. Alternatively, once the number of pictures to be processed in parallel for each temporal identifier is defined, the number of tiles into which the picture having a specific temporal identifier is to be partitioned may be determined.

The decoding apparatus may extract the size of a GOP via the configuration of a reference picture, and may derive a GOP level from the GOP size. Alternatively, the decoding apparatus may derive a GOP level from a temporal level. The GOP level and the temporal level may be used to partition each picture, which will be described later.

Embodiment in which Picture is Partitioned into Tiles Depending on GOP Level

The following Table 3 shows an example of the structure of pic_parameter_set_rbsp indicating a PPS for signaling picture partition information. The picture partition information may be pic_parameter_set_rbsp or may include pic_parameter_set_rbsp. The picture may be partitioned into multiple tiles by pic_parameter_set_rbsp.

TABLE 3

| pic_parameter_set_rbsp( ) { | Descriptor |
|---|---|
| pps_pic_parameter_set_id | ue(v) |
| ... | |
| tiles_enabled_flag | u(1) |
| if( tiles_enabled_flag ) { | |
| num_tile_columns_minus1 | ue(v) |
| num_tile_rows_minus1 | ue(v) |
| uniform_spacing_flag | u(1) |
| if( !uniform_spacing_flag ) { | |
| for( i = 0; i < num_tile_columns_minus1; i++ ) | |
| column_width_minus1[ i ] | ue(v) |
| for( i = 0; i < num_tile_rows_minus1; ++ ) | |
| row_height_minus1[ i ] | ue(v) |
| } | |
| } | |
| parallel_frame_by_gop_level_enable_flag | u(1) |
| if(parallel_frame_by_gop_level_enable_flag) { | |
| num_frame_in_parallel_gop_level3_minus1 | ue(v) |
| num_frame_in_parallel_gop_level2_minus1 | ue(v) |
| } | |
| ... | |
| } | |

pic_parameter_set_rbsp may include the following elements.
parallel_frame_by_gop_level_enable_flag: “parallel_frame_by_gop_level_enable_flag” may be a GOP-level parallel-processing flag indicating whether a picture referring to the PPS is encoded or decoded in parallel with other pictures at the same GOP level.

For example, a parallel_frame_by_gop_level_enable_flag value of “0” may indicate that the picture referring to the PPS is not encoded or decoded in parallel with other pictures at the same GOP level. A parallel_frame_by_gop_level_enable_flag value of “1” may indicate that the picture referring to the PPS is encoded or decoded in parallel with other pictures at the same GOP level.

When the picture is processed in parallel with other pictures, it may be considered that the necessity to partition a single picture into parts and process the parts in parallel is decreased. Therefore, it may be considered that parallel processing for pictures and parallel processing for parts of a single picture may have a correlation therebetween.

The picture partition information may include information about the number of pictures to be processed in parallel (i.e. number-of-pictures-processed-in-parallel information) at GOP level n. The number-of-pictures-processed-in-parallel information at specific GOP level n may correspond to the number of pictures at a GOP level n to which parallel processing may be applied. Here, n may be an integer of 2 or more. The number-of-pictures-processed-in-parallel information may contain the following elements num_frame_in_parallel_gop_level3_minus1 and num_frame_in_parallel_gop_level2_minus1.
num_frame_in_parallel_gop_level3_minus1: “num_frame_in_parallel_gop_level3_minus1” may be the number-of-pictures-processed-in-parallel information at GOP level 3. The number-of-pictures-processed-in-parallel information at GOP level 3 may correspond to the number of pictures at GOP level 3 that can be encoded or decoded in parallel.

For example, the value of “num_frame_in_parallel_gop_level3_minus1+1” may denote the number of pictures at GOP level 3 that can be encoded or decoded in parallel.
num_frame_in_parallel_gop_level2_minus1: “num_frame_in_parallel_gop_level2_minus1” may be the number-of-pictures-processed-in-parallel information at GOP level 2. The number-of-pictures-processed-in-parallel information at GOP level 2 may correspond to the number of pictures at GOP level 2 that can be encoded or decoded in parallel.

For example, the value of “num_frame_in_parallel_gop_level2_minus1+1” may denote the number of pictures at GOP level 2 that can be encoded or decoded in parallel.

By utilizing the signaling of the picture partition information that uses the above-described pic_parameter_set_rbsp, multiple encoded pictures may be decoded using the following procedure.

For example, assuming that the value of the “parallel_frame_bygop_level_enable_flag” in the PPS of the current picture is “1”, and the GOP level of the current picture is 2, num_tile_columns_minus1 and num_tile_rows_minus1 to be applied to the current picture may be redefined by the following Equations 2 and 3:

new_num_tile_columns=(num_tile_columns_minus1+1)/(num_frame_in_parallel_gop_level2_minus1+1) [Equation 2]

new_num_tile_rows=(num_tile_rows_minus1+1)/(num_frame_in_parallel_gop_level2_minus1+1) [Equation 3]

Here, “new_num_tile_columns” may denote the number of tiles arranged in the lateral direction of the partitioned picture (i.e. the number of columns of the tiles). “new_num_tile_rows” may denote the number of tiles arranged in the longitudinal direction of the partitioned picture (i.e. the number of rows of the tiles). The current picture may be partitioned into new_num_tile_columns*new_num_tile_rows tiles.

For example, assuming that the value of “parallel_frame_by_gop_level_enable_flag” in the PPS of the current picture is “1” and the GOP level of the current picture is 3, the num_tile_columns_minus1 and/or num_tile_rows_minus1 to be applied to the current picture may be redefined by the following Equations 4 and 5:

new_num_tile_columns=(num_tile_columns_minus1+1)/(num_frame_in_parallel_gop_level3_minus1+1) [Equation 4]

new_num_tile_rows=(num_tile_rows_minus1+1)/(num_frame_in_parallel_gop_level3_minus1+1) [Equation 5]

The above redefinition may be applied to either or both of new_num_tile_columns and new_num_tile_rows.

According to the above-described Equations 2 to 5, the larger the value of num_frame_in_parallel_gop_level2_minus1 or the like, the smaller the value of new_num_tile_columns. That is, as the value of num_frame_in_parallel_gop_level2_minus1 or num_frame_in_parallel_gop_level3_minus1 becomes larger, the number of tiles that are generated from partitioning may be decreased. Therefore, num_frame_in_parallel_gop_level2_minus1 and num_frame_in_parallel_gop_level3_minus1 may be decrease indication information for decreasing the number of tiles that are generated from the partitioning of the picture. As the number of tiles at the same GOP level that are encoded or decoded in parallel becomes larger, each picture may be partitioned into a smaller number of tiles.

The picture partition information may contain decrease indication information for decreasing the number of tiles that are generated from the partitioning of each picture. Further, the decrease indication information may indicate the degree to which the number of tiles generated from the partitioning of the picture is decreased in relation to encoding or decoding that is processed in parallel.

The picture partition information may contain GOP level n decrease indication information for decreasing the number of tiles generated from the partitioning of a picture at GOP level n. Here, n may be an integer of 2 or more. For example, num_frame_in_parallel_gop_level2_minus1 may be GOP level 2 decrease indication information. Further, num_frame_in_parallel_gop_level3_minus1 may be GOP level 3 decrease indication information.

For example, when the value of “parallel_frame_by_gop_level_enable_flag” in the PPS of the current picture is “0”, the current picture may be partitioned into S tiles using the value of num_tile_columns_minus1 and/or num_tile_columns_minus1 in the PPS of the current picture.

For example, S may be calculated using the following Equation 6:

S=(num_tile_columns_minus1+1)*(num_tile_rows_minus1+1) [Equation 6]

As described above in relation to Equations 2 to 6, the picture partition information may contain GOP level n decrease indication information for a picture at GOP level n. When the number of columns of tiles generated from the partitioning of a picture at GOP level 0 or 1 is w and the number of columns of tiles generated from the partitioning of a picture at GOP level n is w/m, the GOP level n decrease indication information may correspond to m. Alternatively, when the number of rows of tiles generated from the partitioning of a picture at GOP level 0 or 1 is w and the number of rows of tiles generated from the partitioning of a picture at GOP level n is w/m, the GOP level n decrease indication information may correspond to m.

As described above in relation to Equations 2 to 6, a picture partition shape applied to the partitioning of a picture may be determined based on the GOP level of the picture. Further, as described above with reference to FIG. 10, the GOP level of a picture may be determined based on the Picture Order Count (POC) value of the picture.

The GOP level of the picture may be determined depending on the value of a remainder when the POC value of the picture is divided by a predefined value. For example, among multiple pictures in the GOP, a picture at GOP level 3 may be a picture having a remainder of 1 when the POC value of the picture is divided by 2. For example, among the multiple pictures in the GOP, a picture at GOP level 2 may be a picture having a remainder of 2 when the POC value of the picture is divided by 4.

Further, as described above, the same picture partitioning method may be applied to pictures at the same GOP level, among the multiple pictures in the GOP. The picture partition information may indicate that the same picture partitioning method is to be applied to pictures for which a remainder, obtained when the POC value of the pictures is divided by a first predefined value, is a second predefined value, among the multiple pictures.

The picture partition information may indicate a picture partitioning method for pictures at a GOP level of a specific value. Further, picture partition information may define picture partitioning methods for one or more pictures corresponding to one of two or more GOP levels.

Embodiment in which Picture is Partitioned into Tiles Depending on Temporal Level or the Like

The following Table 4 shows an example of the structure of pic_parameter_set_rbsp indicating a PPS for signaling the picture partition information. The picture partition information may be pic_parameter_set_rbsp, or may include pic_parameter_set_rbsp. By pic_parameter_set_rbsp, each picture may be partitioned into multiple tiles.

TABLE 4

| pic_parameter_set_rbsp( ) { | Descriptor |
|---|---|
| pps_pic_parameter_set_id | ue(v) |
| ... | |
| tiles_enabled_flag | u(1) |
| if( tiles_enabled_flag ) { | |
| num_tile_columns_minus1 | ue(v) |
| num_tile_rows_minus1 | ue(v) |
| uniform_spacing_flag | u(1) |
| if( !uniform_spacing_flag ) {\| | |
| for( i = 0; 1 < num_tile_columns_minus1; i++ ) | |
| column_width_minus1[ i ] | |
| for( i = 0; i < num_tile_rows_minus1; i++ ) | |
| row_height_minus1[ i ] | ue(v) |
| } | |
| } | |
| drive_num_tile_enable_flag | u(1) |
| if(drive_num_tile_enable_flag) { | |
| num_tile_level1_minus1 | ue(v) |
| num_tile_level2_minus1 | ue(v) |
| } | |
| ... | |
| } | |

“pic_parameter_set_rbsp” may contain the following elements.
drive_num_tile_enable_flag: “drive_num_tile_enable_flag” may be an unified partition indication flag that indicates whether each picture referring to the PPS is partitioned using one of at least two different methods. Alternatively, “drive_num_tile_enable_flag” may indicate whether the numbers of tiles generated from partitioning are equal to each other when each picture referring to the PPS is partitioned into tiles.

For example, a drive_num_tile_enable_flag value of “0” may indicate that pictures referring to the PPS are partitioned using a single method. Alternatively, a drive_num_tile_enable_flag value of “0” may indicate that, when pictures referring to the PPS are partitioned, the pictures are always partitioned into the same number of tiles.

A drive_num_tile_enable_flag value of “1” may indicate that multiple partition shapes are defined by a single PPS. Alternatively, a drive_num_tile_enable_flag value of “1” may indicate that each picture referring to the PPS is partitioned using one of at least two different methods. Alternatively, a drive_num_tile_enable_flag value of “1” may indicate that the number of tiles, generated as each picture referring to the PPS is partitioned, is not uniform.

It may be considered that, when temporal scalability is applied to a video or a picture, the necessity to partition a single picture into parts and process the parts in parallel is associated with a temporal identifier. It may be considered that the processing of pictures for providing temporal scalability and the partitioning of one picture into parts have a correlation therebetween.

The picture partition information may contain information about the number of tiles (i.e. the number-of-tiles information) for a temporal identifier n. The number-of-tiles information for a specific temporal identifier n may indicate the number of tiles into which a picture at temporal level n is partitioned. Here, n may be an integer of 1 or more.

The number-of-tiles information may contain the following elements num_tile_level1_minus1 and num_tile_level2_minus1. Further, the number-of-tiles information may contain num_tile_levelN_minus1 for one or more values.

The picture partition information or PPS may selectively contain at least one of num_tile_levell_minus1, num_tile_level2_minus1, and num_tile_levelN_minus1 when the value of drive_num_tile_enable_flag is “1”.
num_tile_level1_minus1: “num_tile_level1_minus1” may be level 1 number-of-tiles information for a picture at level 1. The level may be a temporal level.

The level 1 number-of-tiles information may correspond to the number of tiles generated from the partitioning of a picture at level 1. The level 1 number-of-tiles information may be inversely proportional to the number of tiles generated from the partitioning of the picture at level 1.

For example, a picture at level 1 may be partitioned into m/(num_tile_levell_minus1+1) tiles. The value of m may be (num_tile_columns_minus1+1)×(num_tile_rows_minus1+1). Therefore, the larger the value of the level 1 number-of-tiles information, the smaller the number of tiles generated from the partitioning of the picture at level 1.
num_tile_level2_minus1: “num_tile_level2_minus1” may be level 2 number-of-tiles information for a picture at level 2. The level may be a temporal level.

The level 2 number-of-tiles information may correspond to the number of tiles generated from the partitioning of a picture at level 2. The level 2 number-of-tiles information may be inversely proportional to the number of tiles generated from the partitioning of the picture at level 2.

For example, the picture at level 2 may be partitioned into m/(num_tile_level2_minus1+1) tiles. The value of m may be (num_tile_columns_minus1+1)×(num_tile_rows_minus1+1). Therefore, the larger the value of the level 2 number-of-tiles information, the smaller the number of tiles generated from the partitioning of the picture at level 2.
num_tile_levelN_minus1: “num_tile_levelN_minus1” may be level N number-of-tiles information for a picture at level N. The level may be a temporal level.

The level N number-of-tiles information may correspond to the number of tiles that are generated from the partitioning of a picture at level N. The level N number-of-tiles information may be inversely proportional to the number of tiles generated from the partitioning of the picture at level N.

For example, the picture at level N may be partitioned into m/(num_tile_levelN_minus1+1) tiles. The value of m may be (num_tile_columns_minus1+1)×(num_tile_rows_minus1+1). Therefore, the larger the value of the level N number-of-tiles information, the smaller the number of tiles generated from the partitioning of the picture at level N.

“num_tile_levelN_minus1” may be decrease indication information for decreasing the number of tiles that are generated from the partitioning of a picture.

The picture partition information may contain level N decrease indication information for decreasing the number of tiles that are generated from the partitioning of a picture at level N. Here, N may be an integer of 2 or more. For example, num_tile_level2_minus1 may be level 2 decrease indication information. Further, num_tile_level3_minus1 may be level 3 decrease indication information.

By utilizing the signaling of picture partition information that uses the above-described pic_parameter_set_rbsp, multiple encoded pictures may be decoded using the following procedure.

As described above, the number of tiles that are generated from the partitioning of each picture may change depending on the level of the picture. The encoding apparatus and the decoding apparatus may partition each picture using the same method.

For example, when the value of drive_num_tile_enable_flag in the PPS of the current picture is “0”, the current picture may be partitioned into (num_tile_columns_minus1+1)×(num_tile_rows_minus1+1) tiles. Hereinafter, partitioning, performed when the value of drive_num_tile_enable_flag is “0”, is referred to as “basic partitioning”.

For example, when the value of drive_num_tile_enable_flag in the PPS is “1” and the value of num_tile_levelN_minus1+1 is P, a picture at level N may be partitioned into (num_tile_columns_minus1+1)×(num_tile_rows_minus1+1)/P tiles. That is, the number of tiles generated from the partitioning of the picture at level N may be 1/P times the number of tiles generated from basic partitioning. Here, the picture at level N may be partitioned using one of the following methods 1) to 5).

Here, P may be the GOP level of a picture.

The number of horizontal tiles at N level (N-level number of horizontal tiles) may denote the number of tiles arranged in the lateral direction of the picture at level N (i.e. the number of columns of tiles).

The number of vertical tiles at N level (N-level number of vertical tiles) may denote the number of tiles arranged in the longitudinal direction of the picture at level N (i.e. the number of rows of tiles).

The basic number of horizontal tiles may be (num_tile_columns_minus1+1).

The basic number of vertical tiles may be (num_tile_rows_minus1+1).

A picture horizontal length may denote the horizontal length of the picture.

A picture vertical length may denote the vertical length of the picture.

Method 1)

The decrease indication information may be used to adjust the number of horizontal tiles resulting from the partitioning of the picture.

The N-level number of horizontal tiles may be 1/P times the basic number of horizontal tiles, and the N-level number of vertical tiles may be identical to the basic number of vertical tiles.

Method 2)

The decrease indication information may be used to adjust the number of vertical tiles resulting from the partitioning of the picture.

The N-level number of vertical tiles may be 1/P times the basic number of vertical tiles, and the N-level number of horizontal tiles may be identical to the basic number of horizontal tiles.

Method 3)

The decrease indication information may be used to adjust the number of horizontal tiles when the horizontal length of the picture is greater than the vertical length of the picture, and to adjust the number of vertical tiles when the vertical length of the picture is greater than the horizontal length of the picture.

Based on a comparison between the picture horizontal length and the picture vertical length, one of the N-level number of horizontal tiles and the N-level number of vertical tiles, to which 1/P is to be applied, may be determined.

For example, when the picture horizontal length is greater than the picture vertical length, the N-level number of horizontal tiles may be 1/P times the basic number of horizontal tiles and the N-level number of vertical tiles may be identical to the basic number of vertical tiles. When the picture vertical length is greater than the picture horizontal length, the N-level number of vertical tiles may be 1/P times the basic number of vertical tiles, and the N-level number of horizontal tiles may be identical to the basic number of horizontal tiles.

When the picture horizontal length is identical to the picture vertical length, the N-level number of horizontal tiles may be 1/P times the basic number of horizontal tiles, and the N-level number of vertical tiles may be identical to the basic number of vertical tiles. In contrast, when the picture horizontal length is identical to the picture vertical length, the N-level number of vertical tiles may be 1/P times the basic number of vertical tiles, and the N-level number of horizontal tiles may be identical to the basic number of horizontal tiles.

For example, when the picture horizontal length is greater than the picture vertical length, the N-level number of horizontal tiles may be “(num_tile_columns_minus1+1)/P”, and the N-level number of vertical tiles may be “(num_tile_rows_minus1+1)”. When the picture vertical length is greater than the picture horizontal length, the N-level number of horizontal tiles may be “(num_tile_columns_minus1+1)”, and the N-level number of vertical tiles may be “(num_tile_rows_minus1+1)/P”.

Method 4)

The decrease indication information may be used to adjust the number of horizontal tiles when the basic number of horizontal tiles is greater than the basic number of vertical tiles, and to adjust the number of vertical tiles when the basic number of vertical tiles is greater than the basic number of horizontal tiles.

Based on a comparison between the basic number of horizontal tiles and the basic number of vertical tiles, one of the N-level number of horizontal tiles and the N-level number of vertical tiles, to which a decrease corresponding to 1/P times is to be applied, may be determined.

For example, when the basic number of horizontal tiles is greater than the basic number of vertical tiles, the N-level number of horizontal tiles may be 1/P times the basic number of horizontal tiles, and the N-level number of vertical tiles may be identical to the basic number of vertical tiles. When the basic number of vertical tiles is greater than the basic number of horizontal tiles, the N-level number of vertical tiles may be 1/P times the basic number of vertical tiles, and the N-level number of horizontal tiles may be identical to the basic number of horizontal tiles.

When the basic number of horizontal tiles is identical to the basic number of vertical tiles, the N-level number of horizontal tiles may be 1/P times the basic number of horizontal tiles, and the N-level number of vertical tiles may be identical to the basic number of vertical tiles. In contrast, when the basic number of horizontal tiles is identical to the basic number of vertical tiles, the N-level number of vertical tiles may be 1/P times the basic number of vertical tiles, and the N-level number of horizontal tiles may be identical to the basic number of horizontal tiles.

For example, when the basic number of horizontal tiles is greater than the basic number of vertical tiles, the N-level number of horizontal tiles may be “(num_tile_columns_minus1+1)/P”, and the N-level number of vertical tiles may be “(num_tile_rows_minus1+1)”. When the basic number of vertical tiles is greater than the basic number of horizontal tiles, the N-level number of horizontal tiles may be “(num_tile_columns_minus1+1)”, and the N-level number of vertical tiles may be “(num_tile_rows_minus1+1)/P”.

Method 5)

When “P=QR”, the N-level number of horizontal tiles may be “the basic number of horizontal tiles/Q”, and the N-level number of horizontal tiles may be “the basic number of horizontal tiles/R”.

For example, (P, Q, R) may be one of (P, P, 1), (P, 1, P), (T², T, T), (6, 3, 2), (6, 2, 3), (8, 4, 2), and (8, 2, 4), where P, Q, R, and T may each be an integer of 1 or more.

Picture Partition Information for Partitioning Picture into Slices

As described above, the parts of a picture generated from partitioning may be slices. The picture may be partitioned into multiple slices.

In the above-described embodiments, the picture partition information may be signaled by slice_segment_header. The slice_segment_address of the slice_segment_header may be used to partition the picture.

In the following embodiments, slice_segment_address may be included in a PPS rather than slice_segment_header. That is, the PPS including slice_segment_address may be used to partition a picture into multiple slices.

The PPS may define parameters that are applied to a specific picture. Here, at least some of the parameters may be picture partition information and may be used to determine a picture partitioning method.

In an embodiment, the picture partition information included in a single PPS may be applied to multiple pictures. Here, the multiple pictures may be partitioned using one of at least two different methods. In other words, in order to define at least two different picture partitioning methods, a single PPS rather than several PPSs may be used. Even if two pictures are partitioned using different picture partitioning methods, a PPS is not signaled for each picture, and a changed picture partitioning method may be derived based on the picture partition information in a single PPS. For example, the PPS may include picture partition information to be applied to a single picture, and picture partition information to be applied to another picture may be derived based on the PPS. Alternatively, for example, the PPS may include picture partition information to be applied to a single picture, and picture partitioning methods to be applied to multiple pictures may be defined based on the picture partition information.

For example, the PPS may define the number of pictures to be processed in parallel for each GOP level. Once the number of pictures to be processed in parallel for each GOP level is defined, a picture partitioning method for a picture at a specific GOP level may be determined. Alternatively, once the number of pictures to be processed in parallel for each GOP level is defined, the number of slices into which the picture at a specific GOP level is to be partitioned may be determined.

Embodiment in which Picture is Partitioned into Slices Depending on GOP Level

The following Table 5 shows an example of the structure of pic_parameter_set_rbsp indicating a PPS for signaling picture partition information. The picture partition information may be pic_parameter_set_rbsp or may include pic_parameter_set_rbsp. A picture may be partitioned into multiple slices through pic_parameter_set_rbsp. The shapes of the multiple slices may be periodically changed.

TABLE 5

| pic_parameter_set_rbsp( ) { | Descriptor |
|---|---|
| ... | |
| parallel_slice_enabled_flag | u(1) |
| if( parallel_slice_enabled_flag ) { | |
| num_parallel_slice_minus1 | ue(v) |
| slice_uniform_spacing_flag | u(1) |
| if( !slice_uniform_spacing_flag ) { | |
| for( i = 0; i < num_parallel_slice_minus1; i++ ) | |
| parallel_slice_segment_address_minus1[ i ] | ue(v) |
| } | |
| } | |
| parallel_frame_by_gop_level_enable_flag | u(1) |
| if( parallel_frame_by_gop_level_enable_flag ) { | |
| num_frame_in_parallel_gop_level3_minus1 | ue(v) |
| num_frame_in_parallel_gop_level2_minus1 | ue(v) |
| } | |

The following Table 6 illustrates an example of the structure of slice_segment_header when the PPS of Table 5 is used.

TABLE 6

| slice_segment_header ( ) { | Descriptor |
|---|---|
| ... | |
| first_slice_segment_in_pic_flag | u(1) |
| if( !first_slice_segment_in_pic_flag) { | |
| if( dependent_slice_segments_enabled_flag) | |
| dependent_slice_segment_flag | u(1) |
| if( !parallel_slice_enabled_flag) | |
| slice_segment_address | u(v) |
| } | |
| ... | |
| } | |

Referring to Table 5, pic_parameter_set_rbsp may include the following elements.
parallel_slice_enabled_flag: “parallel_slice_enabled_flag” may be slice partition information flag. The slice partition information flag may indicate whether the PPS includes slice partition information to be applied to the picture referring to the PPS.

For example, a parallel_slice_enabled_flag value of “1” may indicate that the PPS includes slice partition information to be applied to the picture referring to the PPS. A parallel_slice_enabled_flag value of “0” may indicate that the PPS does not include slice partition information to be applied to the picture referring to the PPS.

For example, a parallel_slice_enabled_flag value of “0” may indicate that the slice partition information of the picture referring to the PPS is present in slice_segment_header. Here, the slice partition information may contain slice_segment_address.
num_parallel_slice_minus1: “num_parallel_slice_minus1” may be the number-of-slices information corresponding to the number of slices in a partitioned picture.

For example, the value of “num_parallel_slice_minus1+1” may denote the number of slices in the partitioned picture.
slice_uniform_spacing_flag: “slice_uniform_spacing_flag” may be a uniform spacing flag indicating whether the sizes of all slices are equal to each other.

For example, when the value of slice_uniform_spacing_flag is “0”, it may not be considered that the sizes of all slices are equal to each other, and additional information for determining the sizes of individual slices may be required.

For example, when the value of slice_uniform_spacing_flag is “1”, the sizes of all slices may be equal to each other. Further, when the value of slice_uniform_spacing_flag is “1”, the sizes of all slices are equal to each other, and thus slice partition information for the slices may be derived based on the total size of the picture and the number of slices.
parallel_slice_segment_address_minus1 [i]: “parallel_slice_segment_address_minus1” may denote the sizes of slices generated from the partitioning of the picture. For example, the value of “parallel_slice_segment_address_minus1 [i]+1” may indicate the size of an i-th slice. The size unit of a slice may be a CTB. Here, i may be an integer that is equal to or greater than 0 and is less than n, and n may be the number of slices.
parallel_frame_by_gop_level_enable_flag: “parallel_frame_by_gop_level_enable_flag” may be a GOP-level parallel-processing flag that indicates whether a picture referring to the PPS is encoded or decoded in parallel with other pictures at the same GOP level.

For example, a parallel_frame_by_gop_level_enable_flag value of “0” may indicate that the picture referring to the PPS is not encoded or decoded in parallel with other pictures at the same GOP level. A parallel_frame_by_gop_level_enable_flag value of “1” may indicate that the picture referring to the PPS is encoded or decoded in parallel with other pictures at the same GOP level.

When the value of parallel_frame_by_gop_level_enable_flag is “1”, there is a need to adjust the degree of the partitioning of pictures depending on parallelization at the picture level.

The picture partition information may include information about the number of pictures to be processed in parallel (i.e. number-of-pictures-processed-in-parallel information) at GOP level n. The number-of-pictures-processed-in-parallel information at specific GOP level n may correspond to the number of pictures at GOP level n to which parallel processing may be applied. Here, n may be an integer of 2 or more.

The number-of-pictures-processed-in-parallel information may contain the following elements num_frame_in_parallel_gop_level3_minus1 and num_frame_in_parallel_gop_level2_minus1.
num_frame_in_parallel_gop_level3_minus1: “num_frame_in_parallel_gop_level3_minus1” may be the number-of-pictures-processed-in-parallel information at GOP level 3. The number-of-pictures-processed-in-parallel information at GOP level 3 may correspond to the number of pictures at GOP level 3 that can be encoded or decoded in parallel.

For example, the value of “num_frame_in_parallel_gop_level3_minus1+1” may denote the number of pictures at GOP level 3 that can be encoded or decoded in parallel.
num_frame_in_parallel_gop_level2_minus1: “num_frame_in_parallel_gop_level2_minus1” may be the number-of-pictures-processed-in-parallel information at GOP level 2. The number-of-pictures-processed-in-parallel information at GOP level 2 may correspond to the number of pictures at GOP level 2 that can be encoded or decoded in parallel.

For example, the value of “num_frame_in_parallel_gop_level2_minus1+1” may denote the number of pictures at GOP level 2 that can be encoded or decoded in parallel.

By utilizing the signaling of the picture partition information that uses the above-described pic_parameter_set_rbsp, multiple encoded pictures may be decoded using the following procedure.

For example, when the value of “parallel_slice_enabled_flag” in the PPS of the current picture is “1”, the picture may be partitioned into one or more slices. In order to partition the picture into slices, slice_segment_address, which is the slice partition information, must be able to be calculated. After the PPS has been received, slice_segment_address may be calculated based on the elements of the PPS.

When the value of “slice_uniform_spacing_flag” is “1”, the sizes of all slices may be equal to each other. In other words, the size of a unit slice may be calculated depending on the size of the picture and the number of slices, and the sizes of all slices may be equal to the calculated size of the unit slice. Further, slice_segment_address values of all slices may be calculated using the size of the unit slice. When the value of “slice_uniform_spacing_flag is “1”, the size of the unit slice and the slice_segment_address values of the slices may be calculated using the code shown in the following Table 7.

TABLE 7

num_CTB_in_slice = number of CTBs in picture/
(num_parallel_slice_minus1 + 1)
slice_segment_address[0] = 0;
for( i = 1; i < num_parallel_slice_minus1 + 1; i++ ){

slice_segment_address[i] = slice_segment_address[i − 1] +
num_CTB_in_slice;

}

When the value of “slice_uniform_spacing_flag” is “0”, slice_segment_address[i] may be parsed in the PPS. That is, when the value of “slice_uniform_spacing_flag” is “0”, the PPS may include slice_segment_address[i]. Here, i may be an integer that is equal to or greater than 0 and is less than n, and n may be the number of slices.

For example, when the value of “parallel_frame_by_gop_level_enable_flag” in the PPS of the current picture is “1”, num_parallel_slice_minus1 and slice_segment_address[i] may be redefined.

When the value of “parallel_frame_by_gop_level_enable_flag” in the PPS of the current picture is “1”, and the GOP level of the current picture is 2, num_parallel_slice_minus1 to be applied to the current picture may be redefined by the following Equation 7:

new_num_parallel_slice_minus1=(num_parallel_slice_minus1)/(num_frame_in_parallel_gop_level2_minus1+1) [Equation 7]

Here, new_num_parallel_slice_minus1 may correspond to the number of slices in the current picture at GOP level 2. For example, the value of “new_num_parallel_slice_minus1+1” may denote the number of slices in the partitioned current picture.

When the value of “parallel_frame_by_gop_level_enable_flag” in the PPS of the current picture is “1” and the GOP level of the current picture is 3, num_parallel_slice_minus1 to be applied to the current picture may be redefined by the following Equation 8:

new_num_parallel_slice_minus1=(num_parallel_slice_minus1)/(num_frame_in_parallel_gop_level3_minus1+1) [Equation 8]

In this case, new_num_parallel_slice_minus1 may correspond to the number of slices in the current picture at GOP level 3. For example, the value of “new_num_parallel_slice_minus1+1” may denote the number of slices in the partitioned current picture.

In accordance with the above-described Equations 7 and 8, the larger the value of num_frame_in_parallel_gop_level2_minus1 or num_frame_in_parallel_gop_level3_minus1, the smaller the value of new_num_parallel_slice_minus1. In other words, the larger the value of num_frame_in_parallel_gop_level2_minus1 or num_frame_in_parallel_gop_level3_minus1, the smaller the number of slices that are generated from partitioning. Therefore, num_frame_in_parallel_gop_level2_minus1 and num_frame_in_parallel_gop_level3_minus1 may be decrease indication information for decreasing the number of slices to be generated from the partitioning of the picture. As the number of pictures at the same GOP level that are encoded or decoded in parallel becomes larger, each picture may be partitioned into a smaller number of slices.

The picture partition information may contain decrease indication information for decreasing the number of tiles that are generated from the partitioning of each picture. Further, the decrease indication information may indicate the degree to which the number of slices generated from the partitioning of the picture is decreased in relation to encoding or decoding which is processed in parallel. The picture partition information may contain GOP level n decrease indication information for decreasing the number of tiles generated from the partitioning of a picture at GOP level n. Here, n may be an integer of 2 or more. For example, num_frame_in_parallel_gop_level2_minus1 may be GOP level 2 decrease indication information. Further, num_frame_in_parallel_gop_level3_minus1 may be GOP level 3 decrease indication information.

As described above in relation to Equations 7 and 8, the picture partition information may include GOP level n decrease indication information for a picture at GOP level n. When the number of slices generated from the partitioning of a picture at GOP level 0 or 1 is w and the number of slices generated from the partitioning of the picture at GOP level n is w/m, the GOP level n decrease indication information may correspond to m.

By the redefinition of Equations 7 and 8, the slice_segment_address values of the slices in the current picture may be calculated using the code shown in the following Table 8.

TABLE 8

new_num_CTB_in_slice = number of CTBs in picture/
(new_num_parallel_slice_minus1 + 1)
slice_segment_address[0] = 0;
for( i = 1; i < new_num_parallel_slice_minus1+1; i++){

slice_segment_address[i] = slice_segment_address[i − 1] +
new_num_CTB_in_slice;

}

Embodiment in which Picture is Partitioned into Slices Depending on GOP Level or Temporal Level

The following Table 9 shows an example of the structure of pic_parameter_set_rbsp indicating a PPS for signaling picture partition information. The picture partition information may be pic_parameter_set_rbsp or may include pic_parameter_set_rbsp. A picture may be partitioned into multiple slices based on pic_parameter_set_rbsp. The shapes of multiple slices may be periodically changed.

TABLE 9

| pic_parameter_set_rbsp( ) { | Descriptor |
|---|---|
| ... | |
| unified_slice_segment_enabled_flag | u(1) |
| if(unified_slice_segment_enabled_flag) { | |
| num_slice_minus1 | ue(v) |
| slice_uniform_spacing_flag | u(1) |
| for( i = 0; i < num_slice_minus1; i++ ) | |
| unified_slice_segment_address_minus1[ i ] | ue(v) |
| unified_slice_segment_by_gop_level_enable_flag | |
| if(unified_slice_segment_by_gop_level_enable_flag ) { | |
| num_frame_by_gop_level2_minus1 | ue(v) |
| num_frame_by_gop_level3_minus1 | ue(v) |
| } | |

The following Table 10 shows an example of the structure of slice_segment_header when the PPS of Table 9 is used.

TABLE 10

| slice_segment_header ( ) { | Descriptor |
|---|---|
| ... | |
| first_slice_segment_in_pic_flag | u(1) |
| if( !first_slice_segment_in_pic_flag) { | |
| if( dependent_slice_segments_enabled_flag) | |
| dependent_slice_segment_flag | u(1) |
| if( ! unified_slice_segment_enabled_flag) | |
| slice_segment_address | u(v) |
| } | |
| ... | |
| } | |

Referring to Table 9, pic_parameter_set_rbsp may include the following elements.
unified_slice_segment_enabled_flag: “unified_slice_segment_enabled_flag” may be a slice partition information flag. The slice partition information flag may indicate whether a PPS includes slice partition information to be applied to the picture referring to the PPS.

For example, a unified_slice_segment_enabled_flag value of “1” may indicate that the PPS includes slice partition information to be applied to the picture referring to the PPS. A unified_slice_segment_enabled_flag value of “0” may indicate that the PPS does not include slice partition information to be applied to the picture referring to the PPS.

For example, a unified_slice_segment_enabled_flag value of “0” may indicate that the slice partition information of the picture referring to the PPS is present in slice_segment_header. Here, the slice partition information may contain slice_segment_address.
num_slice_minus1: “num_slice_minus1” may be the number-of-slices information corresponding to the number of slices in the partitioned picture. For example, the value of “num_slice_minus1+1” may denote the number of slices in the partitioned picture.
slice_uniform_spacing_flag: “slice_uniform_spacing_flag” may be a uniform spacing flag indicating whether the sizes of all slices are equal to each other.

For example, when the value of slice_uniform_spacing_flag is “0”, it may not be considered that the sizes of all slices are equal to each other, and additional information for determining the sizes of slices may be required. For example, when the value of slice_uniform_spacing_flag is “1”, the sizes of all slices may be equal to each other.

Further, when the value of slice_uniform_spacing_flag is “1”, the sizes of slices are equal to each other, and thus slice partition information for the slices may be derived based on the total size of the picture and the number of slices.
unified_slice_segment_address_minus1 [i]: “unified_slice_segment_address_minus1” may denote the sizes of slices generated from the partitioning of the picture.

For example, the value of “unified_slice_segment_address_minus1[i]+1” may denote the size of an i-th slice. The size unit of the slice may be a CTB. Here, i may be an integer that is equal to or greater 0 and is less than n, and n may be the number of slices.
unified_slice_segment_by_gop_level_enable_flag: “unified_slice_segment_by_gop_level_enable_flag” may be a partitioning method indication flag indicating whether a picture referring to the PPS is partitioned using one of at least two different methods.

Alternatively, unified_slice_segment_by_gop_level_enable_flag may indicate whether the numbers and shapes of slices generated from partitioning are equal to each other when each picture referring to the PPS is partitioned into slices. The shape of a slice may include one or more of the start position of the slice, the length of the slice, and the end position of the slice.

For example, a unified_slice_segment_by_gop_level_enable_flag value of “0” may indicate that a picture referring to the PPS is partitioned using a single method. Alternatively, a unified_slice_segment_by_gop_level_enable_flag value of “0” may indicate that the numbers of slices generated when each picture referring to the PPS is partitioned are always identical to each other, and the shapes of the slices are always uniform.

For example, a unified_slice_segment_by_gop_level_enable_flag value of “1” may indicate that multiple partition shapes are defined by a single PPS. Alternatively, a unified_slice_segment_by_gop_level_enable_flag value of “1” may indicate that a picture referring to the PPS is partitioned using one of at least two different methods. The partitioning of the picture using different methods may mean that the numbers and/or shapes of slices generated from the partitioning of the picture are different from each other.

For example, a unified_slice_segment_by_gop_level_enable_flag value of “1” may indicate that the numbers or shapes of slices generated from the partitioning of a picture referring to the PPS are not uniform.

Alternatively, unified_slice_segment_by_gop_level_enable_flag may be a GOP-level parallel-processing flag that indicates whether a picture referring to the PPS is encoded or decoded in parallel with other pictures at the same GOP level.

For example, a unified_slice_segment_by_gop_level_enable_flag value of “0” may indicate that the picture referring to the PPS is not encoded or decoded in parallel with other pictures at the same GOP level. A unified_slice_segment_by_gop_level_enable_flag value of “1” may indicate that the picture referring to the PPS is encoded or decoded in parallel with other pictures at the same GOP level. When the value of unified_slice_segment_by_gop_level_enable_flag is “1”, there is a need to adjust the degree of the partitioning of pictures depending on parallelization at the picture level.

The picture partition information may include the number-of-frames indication information at GOP level n. The number-of-frames indication information at specific GOP level n may correspond to the number of pictures at GOP level n to which parallel processing may be applied. Here, n may be an integer of 2 or more.

The number-of-frames indication information may contain the following elements num_frame_by_gop_level2_minus1 and num_frame_by_gop_level3_minus1. Further, the number-of-frames indication information may contain num_frame_by_gop_levelN_minus1 for one or more values.

The picture partition information or PPS may selectively include at least one of num_frame_by_gop_level2_minus1, num_frame_by_gop_level3_minus1, and num_frame_by_gop_levelN_minus1 when the value of unified_slice_segment_by_gop_level_enable_flag is “1”.
num_frame_by_gop_level3_minus1: “num_frame_by_gop_level3_minus1” may be the number-of-frames information at GOP level 3. The number-of-frames information at GOP level 3 may correspond to the number of pictures at GOP level 3 that can be encoded or decoded in parallel.

For example, the value of “num_frame_by_gop_level3_minus1+1” may denote the number of pictures at GOP level 3 that can be encoded or decoded in parallel.
num_frame_by_gop_level2_minus1: “num_frame_by_gop_level2_minus1” may be the number-of-frames information at GOP level 2. The number-of-frames information at GOP level 2 may correspond to the number of pictures at GOP level 2 that can be encoded or decoded in parallel.

For example, the value of “num_frame_by_gop_level3_minus1+1” may denote the number of pictures at GOP level 2 that can be encoded or decoded in parallel.

The above description may also be applied to a temporal level. That is, in an embodiment, “GOP” may be replaced by “temporal identifier” and “GOP level” may be replaced by “temporal level”.

By utilizing the signaling of picture partition information that uses the above-described pic_parameter_set_rbsp, multiple encoded pictures may be decoded using the following procedure.

First, when the value of “unified_slice_segment_enabled_flag” in the PPS of the current picture is “1”, the picture may be partitioned into one or more slices.

Further, when the value of “unified_slice_segment_by_gop_level_enable_flag” in the PPS of the current picture is “1”, a picture referring to the PPS may be partitioned using one of at least two different methods.

In order to partition the picture into slices, slice_segment_address, which is the slice partition information, must be able to be calculated. The slice_segment_address may be calculated based on the elements of the PPS after the PPS has been received.

When the value of “slice_uniform_spacing_flag” is “1”, the sizes of all slices may be equal to each other. In other words, the size of a unit slice may be calculated, and the sizes of all slices may be equal to the calculated size of the unit slice. The slice_segment_address values of all slices may be calculated using the size of the unit slice. When the value of “slice_uniform_spacing_flag” is “1”, the size of the unit slice and the unified_slice_segment_address values of respective slices may be calculated using the code shown in the following Table 11:

TABLE 11
num_CTB_in_slice = number of CTBs in picture /
(num_slice_minus1 + 1)
unified_slice_segment_address[0] = 0;
for( i = 1; i < num_slice_minus1 + 1; i++) {

unified_slice_segment_address[i] =
unified_slice_segment_address[i − 1] + num_CTB_in_slice;

}

When the value of “slice_uniform_spacing_flag” is “0”, unified_slice_segment_address[i] may be parsed in the PPS. In other words, when the value of “slice_uniform_spacing_flag” is “0”, the PPS may include unified_slice_segment_address[i]. Here, i may be an integer that is equal to or greater than 0 and is less than n, and n may be the number of slices.

For example, when the value of “unified_slice_segment_by_gop_level_enable_flag” in the PPS of the current picture is “1”, num_slice_minus1 and unified_slice_segment_address[i] may be redefined.

When the value of “parallel_frame_by_gop_level_enable_flag” in the PPS of the current picture is “1” and the GOP level of the current picture is 2, num_slice_minus1 to be applied to the current picture may be redefined by the following Equation 7:

num_slice_minus1=(num_slice_minus1)/(num_frame_by_gop_level2_minus1+1) [Equation 7]

Here, the redefined num_slice_minus1 may correspond to the number of slices in the current picture at GOP Level 2. For example, the value of “num_slice_minus1+1” may denote the number of slices in the partitioned current picture.

When the value of “parallel_frame_by_gop_level_enable_flag” in the PPS of the current picture is “1” and the GOP level of the current picture is 3, num_parallel_slice_minus1 to be applied to the current picture may be redefined by the following Equation 8:

num_slice_minus1=(num_slice_minus1)/(num_frame_by_gop_level3_minus1+1) [Equation 8]

Here, the redefined num_slice_minus1 may correspond to the number of slices in the current picture at GOP level 3. For example, the value of “num_slice_minus1+1” may denote the number of slices in the current picture.

In accordance with the above-described Equations 7 and 8, the larger the value of num_frame_by_gop_level2_minus1 or num_frame_by_gop_level3_minus1, the smaller the value of num_slice_minus1. In other words, the larger the value of num_frame_by_gop_level2_minus1 or num_frame_by_gop_level3_minus1, the smaller the number of slices that are generated from partitioning. Therefore, num_frame_by_gop_level2_minus1 and num_frame_by_gop_level3_minus1 may be decrease indication information for decreasing the number of slices that are generated from the partitioning of the picture. As the number of pictures at the same GOP level that are encoded or decoded in parallel becomes larger, each picture may be partitioned into a smaller number of slices.

The picture partition information may contain decrease indication information for decreasing the number of tiles generated from the partitioning of each picture. Further, the decrease indication information may denote a degree to which the number of slices generated from the partitioning of the picture is decreased in relation to encoding or decoding, which is processed in parallel. The picture partition information may contain GOP level n decrease indication information for decreasing the number of tiles generated from the partitioning of a picture at GOP level n. Here, n may be an integer of 2 or more. For example, num_frame_by_gop_level2_minus1 may be GOP level 2 decrease indication information. Further, num_frame_by_gop_level3_minus1 may be GOP level 3 decrease indication information.

As described above in relation to Equations 7 and 8, the picture partition information may contain GOP level n decrease indication information for a picture at GOP level n. When the number of slices generated from the partitioning of a picture at GOP level 0 or 1 is w and the number of slices generated from the partitioning of the picture at GOP level n is w/m, the GOP level n decrease indication information may correspond to m.

By the redefinition of Equations 7 and 8, unified_slice_segment_address values of slices in the current picture may be calculated using the code shown in the following Table 12:

TABLE 12
new_num_CTB_in_slice = number of CTBs in picture/
(num_slice_minus1 + 1)
unified_slice_segment_address[0] = 0;
for( i = 1; i < num_slice_minus1 + 1; i++ ){
unified_slice_segment_address[i] =

unified_slice_segment_address[i − 1] + num_CTB_in_slice;

}

The following Table 13 shows an example of syntax of a PPS for signaling picture partition information when picture partitioning methods to be applied to multiple pictures are changed depending on the picture.

TABLE 13

| pic_parameter_set_rbsp( ) { | Descriptor |
|---|---|
| ... | |
| tiles_enabled_flag | u(1) |
| entropy_coding_sync_enabled_flag | u(1) |
| if( tiles_enabled_flag ) { | |
| num_tile_columns_minus1 | ue(v) |
| num_tile_rows_minus1 | ue(v) |
| uniform_spacing_flag | u(1) |
| if( !uniform_spacing_flag ) { | |
| for( i = 0; i < num_tile_columns_minus1; i++ ) | |
| column_width_minus1[ i ] | ue(v) |
| for( i = 0; i < num_tile_rows_minus1; ++ ) | |
| row_height_minus1[ i ] | ue(v) |
| } | |
| } | |
| parallel_slice_enabled_flag | u(1) |
| if( parallel_slice_enabled_flag ) { | |
| num_parallel_slice_minus1 | ue(v) |
| slice_uniform_spacing_flag | u(1) |
| if( !slice_uniform_spacing_flag ) { | |
| for( i = 0; i < num_parallel_slice_minus1; i++ ) | |
| parallel_slice_segment_address_minus1[ i ] | ue(v) |
| } | |
| } | |
| parallel_frame_by_gop_level_enable_flag | u(1) |
| if( parallel_frame_by_gop_level_enable_flag ) { | |
| num_frame_in_parallel_gop_level3_minus1 | ue(v) |
| num_frame_in_parallel_gop_level2_minus1 | ue(v) |
| } | |

The following Table 14 shows an example of the syntax of a slice segment header for signaling picture partition information when picture partitioning methods to be applied to multiple pictures are changed depending on the picture.

TABLE 14

| slice_segment_header ( ) { | Descriptor |
|---|---|
| ... | |
| first_slice_segment_in_pic_flag | u(1) |
| if( !first_slice_segment_in_pic_flag) { | |
| if( dependent_slice_segments_enabled_flag) | |
| dependent_slice_segment_flag | u(1) |
| if( !parallel_slice_enabled_flag) | |
| slice_segment_address | u(v) |
| } | |
| ... | |
| } | |

The following Table 15 shows another example of syntax of a PPS for signaling picture partition information when picture partitioning methods to be applied to multiple pictures are changed depending on the picture.

TABLE 15

| | De- |
|---|---|
| pic_parameter_set_rbsp( ) { | scriptor |
| ... | |
| tiles_enabled_flag | u(1) |
| entropy_coding_sync_enabled_flag | u(1) |
| if( tiles_enabled_flag ) { | |
| num_tile_columns_minus1 | ue(v) |
| num_tile_rows_minus1 | ue(v) |
| uniform_spacing_flag | u(1) |
| if( !uniform_spacing_flag ) { | |
| for( i = 0; i < num_tile_columns_minus1; i++ ) | |
| column_width_minus1[ i ] | ue(v) |
| for( i = 0; i < num_tile_rows_minus1; i++ ) | |
| row_height_minus1[ i ] | ue(v) |
| } | |
| } | |
| unified_slice_segment_enabled_flag | u(1) |
| if(unified_slice_segment_enabled_flag) { | |
| num_slice_minus1 | ue(v) |
| slice_uniform_spacing_flag | u(1) |
| for( i = 0, i < num_slice_minus1; i++ ) | |
| unified_slice_segment_address_minus1[ i ] | ue(v) |
| unified_slice_segment_by_gop_level_enable_flag | |
| if(unified_slice_segment_by_gop_level_enable_flag ) { | |
| num_frame_by_gop_level2_minus1 | ue(v) |
| num_frame_by_gop_level3_minus1 | ue(v) |
| } | |
| } | |
| drive_num_tile_enable_flag | u(1) |
| if(drive_num_tile_enable_flag) { | |
| num_tile_level1_minus1 | ue(v) |
| num_tile_level2_minus1 | ue(v) |
| } | |
| ... | |
| } | |

The following Table 16 shows a further example of syntax of a PPS for signaling picture partition information when picture partitioning methods to be applied to multiple pictures are changed depending on the picture.

TABLE 16

| slice_segment_header ( ) { | Descriptor |
|---|---|
| ... | |
| first_slice_segment_in_pic_flag | u(1) |
| if( !first_slice_segment_in_pic_flag) { | |
| if( dependent_slice_segments_enabled_flag) | |
| dependent_slice_segment_flag | u(1) |
| if( ! unified_slice_segment_enabled_flag) | |
| slice_segment_address | u(v) |
| } | |
| ... | |
| } | |

By the above-described embodiments, the picture partition information in a bitstream may be transmitted from the encoding apparatus 1300 to the decoding apparatus 1500.

In accordance with embodiments, even in the case where multiple pictures are partitioned using different methods, picture partition information may not necessarily be signaled for each picture or for each partitioning of each picture.

In accordance with embodiments, even in the case where multiple pictures are partitioned using different methods, picture partition information may not be necessarily encoded for each picture or for each part of the picture. Since encoding and signaling are performed efficiently, the size of an encoded bitstream may be decreased, encoding efficiency may be improved, and the complexity of the implementation of the decoding apparatus 1500 may be decreased.

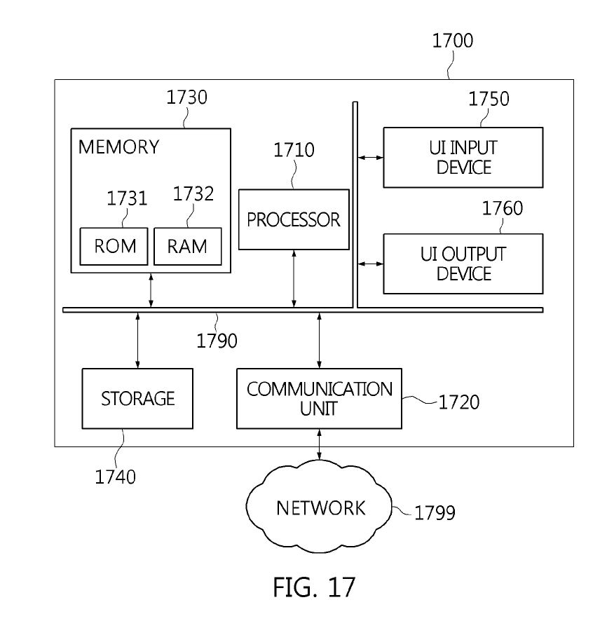

FIG. 17 is a configuration diagram of an electronic device in which an encoding apparatus and/or a decoding apparatus are implemented.

In an embodiment, at least some of the control unit 1310, the encoding unit 1320, and the communication unit 1330 of the encoding apparatus 1300 may be program modules and may communicate with an external device or system. The program modules may be included in the encoding apparatus 1300 in the form of an operating system, an application program module, and other program modules.

Further, in an embodiment, at least some of the control unit 1510, the decoding unit 1520, and the communication unit 1530 of the decoding apparatus 1500 may be program modules and may communicate with an external device or system. The program modules may be included in the decoding apparatus 1500 in the form of an operating system, an application program module, and other program modules.

The program modules may be physically stored in various types of well-known storage devices. Further, at least some of the program modules may also be stored in a remote storage device that is capable of communicating with the encoding apparatus 1300 or a remote storage device that is capable of communicating with the decoding apparatus 1500.

The program modules may include, but are not limited to, a routine, a subroutine, a program, an object, a component, and a data structure for performing functions or operations according to an embodiment or for implementing abstract data types according to an embodiment.

The program modules may be implemented using instructions or code executed by at least one processor of the encoding apparatus 1300 or at least one processor of the decoding apparatus 1500.

The encoding apparatus 1300 and/or the decoding apparatus 1500 may be implemented as an electronic device 1700 illustrated in FIG. 17. The electronic device 1700 may be a general-purpose computer system functioning as the encoding apparatus 1300 and/or the decoding apparatus 1500.

As shown in FIG. 17, the electronic device 1700 may include at least one processor 1710, memory 1730, a user interface (UI) input device 1750, a UI output device 1760, and storage 1740, which communicate with each other through a bus 1790. The electronic device 1700 may further include a communication unit 1720 connected to a network 1799. The processor 1710 may be a Central Processing Unit (CPU) or a semiconductor device for executing processing instructions stored in the memory 1730 or the storage 1740. Each of the memory 1730 and the storage 1740 may be any of various types of volatile or nonvolatile storage media. For example, the memory may include at least one of Read Only Memory (ROM) 1731 and Random Access Memory (RAM) 1732.

The encoding apparatus 1300 and/or the decoding apparatus 1500 may be implemented in a computer system including a computer-readable storage medium.

The storage medium may store at least one module required in order for the electronic device 1700 to function as the encoding apparatus 1300 and/or the decoding apparatus 1500. The memory 1730 may store at least one module and may be configured to be executed by the at least one processor 1710.

Functions related to communication of data or information of the encoding apparatus 1300 and/or the decoding apparatus 1500 may be performed by the communication unit 1720. For example, the control unit 1310 and the encoding unit 1320 of the encoding apparatus 1300 may correspond to the processor 1710, and the communication unit 1330 may correspond to the communication unit 1720. For example, the control unit 1510 and the decoding unit 1520 of the encoding apparatus 1500 may correspond to the processor 1710 and the communication unit 1530 may correspond to the communication unit 1720.

In the above-described embodiments, although the methods have been described based on flowcharts as a series of steps or units, the present invention is not limited to the sequence of the steps and some steps may be performed in a sequence different from that of the described steps or simultaneously with other steps. Further, those skilled in the art will understand that the steps shown in the flowchart are not exclusive and may further include other steps, or that one or more steps in the flowchart may be deleted without departing from the scope of the invention.

The above-described embodiments according to the present invention may be implemented as a program that can be executed by various computer means and may be recorded on a computer-readable storage medium. The computer-readable storage medium may include program instructions, data files, and data structures, either solely or in combination. Program instructions recorded on the storage medium may have been specially designed and configured for the present invention, or may be known to or available to those who have ordinary knowledge in the field of computer software. Examples of the computer-readable storage medium include all types of hardware devices specially configured to record and execute program instructions, such as magnetic media, such as a hard disk, a floppy disk, and magnetic tape, optical media, such as compact disk (CD)-ROM and a digital versatile disk (DVD), magneto-optical media, such as a floptical disk, ROM, RAM, and flash memory. Examples of the program instructions include machine code, such as code created by a compiler, and high-level language code executable by a computer using an interpreter. The hardware devices may be configured to operate as one or more software modules in order to perform the operation of the present invention, and vice versa.

As described above, although the present invention has been described based on specific details such as detailed components and a limited number of embodiments and drawings, those are merely provided for easy understanding of the entire invention, the present invention is not limited to those embodiments, and those skilled in the art will practice various changes and modifications from the above description.

Accordingly, it should be noted that the spirit of the present embodiments is not limited to the above-described embodiments, and the accompanying claims and equivalents and modifications thereof fall within the scope of the present invention.

1. A video encoding method, comprising:
performing encoding on multiple pictures; and
generating data that includes picture partition information and the multiple encoded pictures,
wherein each of the multiple pictures is partitioned using one of at least two different methods corresponding to the picture partition information.

2. A video decoding method, comprising:
a control unit for acquiring picture partition information; and
a decoding unit for performing decoding on multiple pictures,
wherein each of the multiple pictures is partitioned using one of at least two different methods based on the picture partition information.

3. A video decoding method, comprising:
decoding picture partition information; and
performing decoding on multiple pictures based on the picture partition information,
wherein each of the multiple pictures is partitioned using one of at least two different methods.

4. The video decoding method of claim 3, wherein:
a first picture of the multiple pictures is partitioned based on the picture partition information, and
a second picture of the multiple pictures is partitioned based on additional picture partition information derived based on the picture partition information.

5. The video decoding method of claim 3, wherein the multiple pictures are partitioned using a picture partitioning method that is defined by the picture partition information and is periodically changed.

6. The video decoding method of claim 3, wherein the multiple pictures are partitioned using a picture partitioning method that is defined by the picture partition information and is changed according to a rule.

7. The video decoding method of claim 3, wherein the picture partition information indicates that an identical picture partitioning method is to be applied to pictures for which a remainder, obtained when a picture order count value of the pictures is divided by a first predefined value, is a second predefined value, among the multiple pictures.

8. The video decoding method of claim 3, wherein the picture partition information indicates a number of tiles into which each of the multiple pictures is to be partitioned.

9. The video decoding method of claim 3, wherein each of the multiple pictures is partitioned into a number of tiles determined based on the picture partition information.

10. The video decoding method of claim 3, wherein each of the multiple pictures is partitioned into a number of slices determined based on the picture partition information.

11. The video decoding method of claim 3, wherein the picture partition information is included in a Picture Parameter Set (PPS).

12. The video decoding method of claim 11, wherein the PPS includes a unified partition indication flag indicating whether a picture referring to the PPS is partitioned using one of at least two different methods.

13. The video decoding method of claim 3, wherein the picture partition information indicates, for a picture at a specific level, a picture partitioning method corresponding to the picture.

14. The video decoding method of claim 13, wherein the level is a temporal level.

15. The video decoding method of claim 3, wherein the picture partition information includes decrease indication information for decreasing a number of tiles generated from partitioning of each picture.

16. The video decoding method of claim 15, wherein:
the decrease indication information is configured to adjust a number of horizontal tiles when a picture horizontal length is greater than a picture vertical length and to adjust a number of vertical tiles when the picture vertical length is greater than the picture horizontal length,
the picture horizontal length is a horizontal length of the picture,
the picture vertical length is a vertical length of the picture,
the number of horizontal tiles is a number of tiles arranged in a lateral direction of the picture, and
the number of vertical tiles is a number of tiles arranged in a longitudinal direction of the picture.

17. The video decoding method of claim 3, wherein the picture partition information includes level n decrease indication information for decreasing a number of tiles generated from partitioning of a picture at level n.

18. The video decoding method of claim 3, wherein the picture partition information includes decrease indication information for decreasing a number of slices generated from partitioning of each picture.

19. The video decoding method of claim 3, wherein the picture partition information includes level n decrease indication information for decreasing a number of slices generated from partitioning of a picture at level n.

20. The video decoding method of claim 3, wherein the at least two different methods are different from each other for a number of slices generated from partitioning of each picture.
